(19) United States
(12) Patent Application Publication
(10) Pub. No.: US 2006/0234572 A1
(43) Pub. Date: Oct. 19, 2006

(54) Shear thickening fluid containment in polymer composites

(75) Inventors: Norman Wagner, Newark, DE (US); John E. Kirkwood, Stanford, CA (US); Ronald G. Egres JR., Newark, DE (US)

Correspondence Address: CONNOLLY BOVE LODGE & HUTZ, LLP, P O BOX 2207, WILMINGTON, DE, 19899, US

(73) Assignee: UD Technology Corporation, Newark, DE (US)

(21) Appl. No.: 11/260,742

(22) Filed: Oct. 27, 2005

Related U.S. Application Data
(60) Provisional application No. 60/622,371, filed on Oct. 27, 2004.

(51) Int. Cl. B32B 5/02

(52) U.S. Cl. 442/59

(57) ABSTRACT

The rheology of a colloidal PEG-based shear thickening fluid emulsified with silicone oil is studied in detail. A shear thickening response is observed in the viscosity-shear rate curves for volume fractions as low as 10% of STF in the silicone emulsion. From the log additivity rule, we prove the system to be classified as both a positive and negative deviating blend at zero shear. This interesting behavior is due to phase inversion. The rubbers are formed by emulsifying the shear thickening fluid within the rubber precursors and then adding the catalyzing agent. It was possible to contain STF in each of the silicones tested and the rubbers exhibited different behavior with incased STF. Shear thickening fluid was added to open cell polyurethane to create a Foam-STF composite which was found to exhibit an obvious shear thickening response. The foam composite became solid like and absorbed energy at high strains while still maintaining its fluid-like response at low strain rates.

### RELATED APPLICATIONS

This application claims benefit to provisional application Ser. No. 60/622,371 filed Oct. 27, 2004 which is incorporated by reference in its entirety.

### BACKGROUND OF THE INVENTION

There is significant interest in understanding the flow properties and microstructure formation of immiscible blends of liquids. Such blends occur often in many systems and processes of practical importance. For example immiscible fluids are often used in direct mass contacting operation, such as extraction, while many foods, cosmetics, liquid soaps, and other consumer products are delivered or processed as mixtures of immiscible fluids. Immiscible polymer blends are formulated to achieve physical properties between the limits of the pure components, as well as imparting new characteristics arising from the presence of an interface.

From a theoretical standpoint the problem has not been solved, as how to describe the immiscible fluid mixtures and so one must rely on experimentation and semi-empirical models for predictions of rheological and material properties. Much work has been done to describe polymer blend systems (Utracki, L. A., “On the viscosity-concentration dependence of immiscible polymer blends,” J. Rheol 35(8), 1615-1637 (1991)) so that industrial processing can be streamlined and flow morphology more aptly controlled.

Some of the difficulties in studying emulsions arise because: 1) they are inherently unstable unless additional additives such as surfactants are added; 2) energy is generally required to disperse one fluid in another; and 3) the state of dispersion depends on history. Within the emulsion there is a varying range of morphologies possible, from dispersed to co-continuous to phase inverted. Under complex flow the fluid-fluid dispersions often take form of droplets, threads or sheets of one fluid dispersed in a continuous matrix of another (Astruc, M., Navard, P., “A flow-induced phase inversion in immiscible polymer blends containing a liquid-crystalline polymer studied by in situ optical microscopy,” J. Rheol. 44(4) 693-712 (2000)), (Wetzel, E. D., Tucker, C. L., “Droplet deformation in dispersions with unequal viscosities and zero interfacial tension,” J. Fluid Mech. 426, 199-228 (2001)), (Wetzel, E. D., Tucker, C. L., “Microstructural evolution during complex laminar flow of liquid-liquid dispersions,” J. Non-Newtonian Fluid Mech. 101, 21-41 (2001)). The mechanical properties, appearance, permeability, and rheology of polymer blends are strongly influenced by their multiphase structure (Van Eijndhoven-Rivera, M. J., Wagner, N. J., Hsiao, B., “Correlation of the Minor-Phase Orientation to the Flow-Induced Morphological Transitions in Thermotropic Liquid Crystalline Polymer/PBT Blends.” J. Poly. Sci. B 36, 1769-1780 (1998)), (Wetzel, E. D., Tucker, C. L., “Microstructural evolution during complex laminar flow of liquid-liquid dispersions,” J. Non-Newtonian Fluid Mech. 101, 21-41 (2001)). The a priori knowledge of flow properties of a two component blend is very difficult but important, leading some to use of finite element analysis to simulate Rheological behavior (Zhao, J., Mascia, L., Nassehi, V., “Simulation of the Rheological Behavior of Polymer Blends by Finite Element Analysis,” Adv. Polymer Tech. 16(3), (1997)). If the components are non-Newtonian (Newtonian fluids are most often studied) the predictions become even more complex due to the need of domain structure knowledge (Kitade, S., Ichikawa, A., Imura, N., Takahashi, Y., Noda, I., “Rheological properties and domain structures of immiscible polymer blends under steady and oscillatory shear flows,” J. Rheol. 41(5), 1039-1060 (1997)). Polymer blend morphology and rheology is complex as they are affected by various factors such as the component rheological characteristics, composition, interfacial tension, and domain structure (Kitade, S., Ichikawa, A., Imura, N., Takahashi, Y., Noda, I., “Rheological properties and domain structures of immiscible polymer blends under steady and oscillatory shear flows,” J. Rheol. 41(5), 1039-1060 (1997)).

The general formulism for an emulsion, such as the one under study, is treatment of one phase as continuous and the second as discrete droplets, either ellipsoidal or spherical in shape. The droplets are assumed to deform under flow; however this deformation is quite complex and is dependent on a second rank tensor describing the shape and orientation of the interfacial area between fluids (Edwards, B. J., Dressler, M., “A rheological model with constant approximate volume for immiscible blends of ellipsoidal droplets,” Rheol. Acta 42, 326-337 (2003)), (Wetzel, E. D., Tucker, C. L., “Droplet deformation in dispersions with unequal viscosities and zero interfacial tension,” J. Fluid Mech. 426, 199-228 (2001)). A more in-depth discussion of droplet deformation can be found in Cavallo, Dagreou, S., Allal, A., Marin, G., Mendiboure, B., “Linear viscoelastic properties of emulsions and suspensions with thermodynamic and hydrodynamic interactions,” Rheo Acta 41, 500-513 (2003), Edwards, or Wetzel (Wetzel, E. D., Tucker, C. L., “Droplet deformation in dispersions with unequal viscosities and zero interfacial tension,” J. Fluid Mech. 426, 199-228 (2001), Wetzel, E. D., Tucker, C. L., “Microstructural evolution during complex laminar flow of liquid-liquid dispersions,” J. Non-Newtonian Fluid Mech. 101, 21-41 (2001)). Even more important to the current work investigation is the results of Kernick and Wagner (Kernick, W., Wagner, N. J., “The role of liquid-crystalline polymer rheology on the evolving morphology of immiscible blends containing liquid-crystalline polymers,” J. Rheol. 43(3), 521-549 (1999)) showing that non-Newtonian fluids in emulsion can lead to dramatic changes in morphology under flow due to shear rate dependence of morphology.

The analysis of the emulsion under study is performed with the premise that the state of the discrete phase droplets can be understood through consideration of droplet breakup and coalescence (Doi, M., Ohta, T., “Dynamics and rheology of complex interfaces. I,” J. Chem. Phys. 95, 1242-1248 (1991)), (Taylor, G. I., “The visocity of a fluid containing small drops of another fluid,” Proc. R. Soc. London Ser. A 138, 41-48 (1932)), (Taylor, G. I., “The formation of emulsions in definable fields of flow,” Proc. R. Soc. London Ser. A 146, 501-523 (1934)). Work by Rusu (Rusu, D., Peuvrel-Disdier, E., “In situ characterization by small angle light scattering of the shear-induced coalescence mechanisms in immiscible polymer blends,” J. Rheol. 43(6), 1391-1409 (1999)) highlights in detail the complexities of the dynamic equilibrium between droplet coalescence and dispersion mechanisms. The droplet coalescence is broken down into four stages (i) the collision between the two drops; (ii) the drainage of the matrix film separating the colliding drops; (iii) the rupture of the matrix film; and (iv) the drop coalescence. The work on the shear-induced coalescence of droplets is consistent with previously understood mechanisms. However, the prediction of final morphology (particle size distribution and state of dispersion), in connection with the magnitude of deformation and stresses, is very difficult (Iza, M., Bousmina, M., “Nonlinear rheology of immiscible polymer blends: Step strain experiments,” J. Rheol. 44(6), 1363-1384 (2000)).

The establishment of a stable morphology is governed by two kinetics: rapid retraction process of elongated droplets leading to an increase of terminal relaxation time followed by breakup via Rayleigh instabilities and end-pinching mechanisms (Iza, M., Bousmina, M., “Nonlinear rheology of immiscible polymer blends: Step strain experiments,” J. Rheol. 44(6), 1363-1384 (2000)). Astruc, M., Navard, P., “A flow-induced phase inversion in immiscible polymer blends containing a liquid-crystalline polymer studied by in situ optical microscopy,” J. Rheol. 44(4) 693-712 (2000) gives the important parameters to determine the final or steady-state morphology as the composition of the blend, shear rate, viscosity and elasticity of the two phases, interfacial tension, and time of mixing.

Adding more of the dispersed phase can lead to the formation of a co-continuous morphology or phase inversion. Ageropoulos, G. N., Weissert, F. C., Biddison, P. H., Bohm, G. A., “Heterogeneous blends of polymers. Rheology and Morphology,” Rubber Chem. Technol. 49, 93-104 (1976) concluded that the point of phase inversion is reached when the torque ratio of the components is equal to the component volume fraction ratio. Work by Utracki (Utracki, L. A., “On the viscosity-concentration dependence of immiscible polymer blends,” J. Rheol 35(8), 1615-1637 (1991)) suggests the phase inversion point can be predicted based on the dependence of the viscosity on the volume fraction of monodispersed hard spheres in the matrix, as proposed by Krieger and Dougherty (Krieger, I. M., Dougherty, T. J., “A mechanism for non-Newtonian flow in suspensions of rigid spheres,” Trans. Soc. Theol. 3, 137-152 (1959)). A more in depth analysis of the previous work in the area of phase inversion can be found in work by Astruc, M., Navard, P., “A flow-induced phase inversion in immiscible polymer blends containing a liquid-crystalline polymer studied by in situ optical microscopy,” J. Rheol. 44(4) 693-712 (2000).

The emulsion under study is a 3-phase mixture with solid particles, polyethylene glycol, and silicone oil (FIG. 1). The solid particles are suspended in the polyethylene glycol phase at a high loading to produce a shear thickening fluid. The particles are not added to the silicone phase and the emulsion can be reduced to two phases.

Shear thickening fluids (STFs) are fluids whose viscosity increases with shear rate. Of particular interest are discontinuous STFs, which at high shear rates transform into a material with solid-like properties. A typical example of a discontinuous STF is a stabilized suspension of rigid colloidal particles with a high loading fraction of particles. Such systems have been studied for many different combinations of fluid matrix and particle size and compositions (Egres, R. G., Lee, Y. S., Kirkwood, J. E., Kirkwood, K. M., Wetzel, E. D., and Wagner, N. J., “Novel flexible body armor utilizing shear thickening fluid composites.” Proceedings of 14^{th} International Conference on Composite Materials. San Diego, Calif. Jul. 14-18, 2003), (Lee, Y. S., Wagner, N. J., “Dynamic properties of shear thickening colloidal suspensions,” Rheol Acta 42,199-208 (2003), (Shenoy, S., Wagner, N. J., Bender, J. W., “E-FiRST: Electric field responsive shear thickening fluids,” Rheo Acta 42,287-294 (2003)). The shear thickening in the colloidal suspension is due to the formation of jamming clusters, or hydroclusters, Lee, Y. S., Wagner, N. J., “Dynamic properties of shear thickening colloidal suspensions,” Rheol Acta 42,199-208 (2003) bound together by hydrodynamic lubrication forces. The hydrocluster growth and collision eventually result in a percolated arrangement of the rigid particles across macroscopic dimension. This microstructural transformation leads to the bulk solid-like behavior. Upon relaxation of the applied stresses, the rigidized material typically relaxes to the low strain rate, fluid-like behavior (Eric D. Wetzel, Y. S. Lee, R. G. Egres, K. M. Kirkwood, J. E. Kirkwood, and N. J. Wagner, “The Effect of Rheological Parameters on the Ballistic Properties of Shear Thickening Fluid (STF) Kevlar Composites” NUMIFORM, 2004).

Previous literature is limited to a few investigations dealing with a shear thickening phase in an emulsion (Pal, R., “Non-idealities in the rheological behavior of emulsions,” Chem. Eng. Comm. 121, 81-97 (1993)), (Tan, H., Tam, K. C., Jenkins, R. D., “Rheological Properties of Semidilute hydrophobically Modified Alkali-Soluble Emulsion Polymers in Sodium Dodecyl Sulfate and Salt Solutions.” Langmuir 16, 5600-5606 (2000). Pal (Pal, R., “Non-idealities in the rheological behavior of emulsions,” Chem. Eng. Comm. 121, 81-97 (1993)) studied the rheological behavior of pure component EDM oil, a non-discontinuously shear thickening fluid, and emulsions containing EDM. Results showed that with the addition of an emulsifying agent the oil could be emulsified in deionized water (Newtonian fluid) resulting in an emulsion with Newtonian viscosity behavior. Studying the rheology of immiscible dispersions of a non-Newtonian liquid-crystalline polymer Kernick and Wagner found dramatic changes in morphology under flow due to shear rate dependence of morphology. It is therefore expected that an emulsion containing the highly non-Newtonian shear thickening fluid will have a change in morphology under different flow conditions.

We determined the rheological properties of an emulsion containing a polyethylene glycol based discontinuous shear thickening fluid and silicone oil. The systems studied are novel and there is no known methodology for predicting the rheology and morphology of emulsions containing a shear thickening fluid. The system is also hypothesized to follow standard shear droplet morphology, with competition between coalescence and breakup.

Shear-thickening fluids have been shown to have utility in the fabrication of energy dissipative devices, such as shock absorbers (Hesse, H., U.S. Pat. No. 4,503,952), (Rosenberg, B. L., U.S. Pat. No. 3,833,952), (Sheshimo, K., U.S. Pat. No. 4,759,428) and more recently in the fabrication of ballistic fabric composites (Egres, R. G., Lee, Y. S., Kirkwood, J. E., Kirkwood, K. M., Wetzel, E. D., and Wagner, N. J., “Novel flexible body armor utilizing shear thickening fluid composities.” Proceedings of 14^{th} International Conference on Composite Materials. San Diego, Calif. Jul. 14-18, 2003), (Lee, Y. S., Wetzel, E. D., and Wagner, N. J., “The ballistic impact characteristics of Kevlar woven fabrics impregnated with a colloidal shear thickening fluid”, J. Mat. Sci. 38, 2825-2833 (2003), (Eric D. Wetzel, Y. S. Lee, R. G. Egres, K. M. Kirkwood, J. E. Kirkwood, and N. J. Wagner, “The Effect of Rheological Parameters on the Ballistic Properties of Shear Thickening Fluid (STF) Kevlar Composites” NUMIFORM, 2004). There is considerable interest in incorporating STF's into other materials. PCT/US2004/015813 entitled “Advanced Body Armor using a shear thickening fluid” is incorporated by reference in its entirety for all useful purposes. Incorporation of STF's into rubbers and foams is discussed below.

Within the scope of this invention, the shear thickening fluid is defined as any fluid that exhibits an increase in viscosity with increasing shear rate or applied stress.

The shear thickening fluids may be concentrated dispersions of particulates within a fluid medium that exhibit an increase in viscosity with increasing applied stress, the particles within the fluid would preferably have a smallest dimension being less than 10 microns, more preferably, less than 1 micron, as well as true nanoparticles being below 100 nm in smallest dimension. Particles can be of any solid material, including spherical amorphous silica such as that produced via Stober type synthesis, synthetic inorganic particles synthesized via solution precipitation processes such as precipitated calcium carbonate, or synthesized by gel-sol techniques (hematite, TiO2), or fumed silica, or carbon black. Natural inorganic particulates such as montorillonite and kaolin clays can be dispersed in solvents and have been shown to exhibit shear thickening behavior. Ground mineral powders, such as quartz, calcite, talcs, gypsum, mica can be dispersed in liquid mediums and exhibit shear thickening behavior. The solid dispersed phase can also be polymeric in nature, such as plastisols generated through emulsion polymerization processes such poly(methyl methacrylate) (PMMA), polystyrene (PS) microspheres such as those available from Polysciences or Bangs Laboratories, Inc.

The shear thickening fluid could alternatively be a surfactant solution which have been shown in the literature to clearly exhibit a shear thickening transition, or any fluid which exhibits an increase in viscosity with increasing applied shear stress or shear rate.

Solid-Shear Thickening Fluid Composites

Inventive Method 1

One method by which the inventive composite of a solid material and a shear thickening fluid could be fabricated is through impregnating the shear thickening fluid into a porous solid scaffold material. Such solid material structures could be fabric-like or textile-based in nature, including, but not limited to fiber yarns, woven fabrics, spunlaced or spunbonded non-woven fabric and the like. The aforementioned materials could be comprised of natural fibers such as cotton, silk, hemp or any natural occurring fiber material. Alternatively, the porous scaffold could be comprised of synthetic materials such as polymer fibers, fiberglass, carbon fiber, metal fibers or mesh etc. Suitable polymeric fibers could include polyaramids (KEVLAR®, NOMEX®), Nylon, polyesters such as polyethylene terephthalate, polyolefins such as polyethylene, polypropylene, particularly gel-spun polyolefins exhibiting high strength as sold under the trade name SPECTRA® (Honeywell Corp.).

A second type of scaffold material could be a porous article produced through fusion of particles through heat and compression, such as isostatic compression. Such techniques have been used to produce shaped porous plastic article, porous metals, porous glass, porous ceramics, and the like.

A third type of scaffold materials would include open cell foams, such as those produced from polyurethanes, polyolefins or any polymeric material. Another porous scaffold material that would have utility is expanded polytetrafluoroethylene (ePTFE) such found in several materials sold under the trade name GORE-TEX® (W. L. Gore and Associates, Inc.), or microporous or expanded polyethylene.

A fourth type of scaffold material would include porous natural materials, including but not limited to wood, porous stone such as sandstone, pumice etc., the skeletons of marine organisms including corals and sponges.

Inventive Method 2

A second method by which a solid (referred to herein as the second material)-shear thickening fluid composite containing discrete or co-continuous regions of shear thickening fluids can be fabricated is via mixing STF with a liquid or fluid-like component that can subsequently be converted to a solid through heating, cooling, chemical reaction, etc. Candidate materials would preferably exhibit little solubility with the liquid suspending medium used to generate the shear thickening fluid, at least on the time scales and at the processing conditions required to transition the material from a liquid to a solid. Control of the morphology can be tuned based on choice of shear thickening fluid and second material liquid component, the relative compositions of the STF and second material liquid component, shear or processing conditions, and the addition of process adjuvants such as surfactants, fillers and the like.

One type of second material would include reactive polymeric materials that cure or crosslink to form solids. Reactive polymers include polyurethanes that cure through the chemical reaction of components (polyols and isocyanates), epoxies that cure through the addition of a catalyst, and UV curable resins. A preferred second material of this type would be from the class of elastomeric or elastomeric gel materials, such as silicone rubber (cross-linked PDMS) or silicone gels and the like, which can be relatively low viscosity liquids prior to cross-linking, whereafter they form resilient materials with good rebound characteristics. A variety of elastomers exist to provide a wide range of properties such as chemical and solvent resistance, temperature resistance, and hardness (durometer). These materials could be mixed with shear thickening fluids at room temperature to disperse the shear thickening fluids adequately and to achieve the desired composite morphology or shear thickening fluid droplet size. The liquid-like second material could subsequently be cured, or the curing could be accelerated through heating or the addition of additional components that catalyze the reaction and transform the second material into a solid.

Another type of second materials would include melt processable polymers or thermoplastic elastomers (TPE). Melt processable polymers include but are not limited to polyolefins such as polyethylene and polypropylene, nylon, polymethylmethacrylate, polyvinylchloride, polyethylene terephthalate (PET), polycarbonate and the like. Thermoplastic elastomers would include such as materials as those sold under the trade names Santoprene™ (Exxon Mobil Chemical), and Hytrel® (DuPont Company). In this instance, increased temperature is used to liquefy a polymeric material. At the processing conditions required to achieve the desired melt flow properties of the polymer second material, the shear thickening fluid would be compounded with the polymer melt to achieve the desired level of mixing and microstructure. The temperature would subsequently be reduced to generate the solid polymer-shear thickening fluid composite.

End use articles can be generated from the aforementioned novel materials through injection molding, thermoforming, extrusion, and conceivably any method used to fabricate articles from the second polymeric material alone as known to those skilled in the art

Alternatively these materials could be incorporated as discrete laminar regions between layers of the second material, such as between layers of polymeric materials and composites (such as polycarbonate and fiberglass reinforced epoxy) glass, ceramic, or metal films or sheet. Such laminar composites could exhibit dramatically improved ballistic or impact related energy dissipation, as the compression associated with impact would initiate improved energy dissipation between the second material layers within the construction

Inventive Method 3

Alternatively, the second material could be a building material such as concrete or asphalt. The presence of shear thickening fluid could absorb damaging impact energy within these materials which contribute to fatigue failure or catastrophic failure of articles made therefrom.

Liquid-Shear Thickening Fluid Composites

One embodiment of the invention relates to a composite liquid-liquid mixture, or blend, where at least one component in the mixture is a fluid that exhibits a shear thickening transition, (increase in viscosity resulting from increased shear stress or shear rate). We have shown that blends of shear thickening fluids incorporated into a second fluid medium exhibit rheological behavior indicating their ability to impart improved energy dissipative capabilities to composites made therefrom.

Such a fluid having utility when incorporated as a coating, impregnated into or dispersed within a solid material. Such a fluid could serve as a layer between two materials such as glass, metals, plastics to provide energy dissipative characteristics. One application for such a fluid would be to impregnate or imbibe it into a porous solid scaffold material. Such solid material structures would include, but are not limited to fiber yarns, woven fabric, spunlaced or spunbonded nonwoven fabric, an open cell foam (to form a co-continuous network with the solid open cell foam network/scaffold), or to exist as discrete droplets within a solid. The composition of the yarns or fabrics would include synthetic materials, such as polymers, elastomers, as well as inorganic fibrous materials. Polymeric fibers include high modulus polymeric fibers such as polyaramids poly(phenylene diamine terephthalate) sold by Dupont under the registered trademark Kevlar®, nylon, polyester, Dacron etc. Elastomeric fibers include polyisoprene, other fibers included within the scope of this invention include natural occurring fibers such as cotton, wool, hemp. etc. High modulus inorganic fibers and fiber yarns and fabrics such a graphite, E-glass, S-glass, ceramics fibers.

The novel blend could be incorporated as discrete droplets or a co-continuous phases within a solid material by methods described earlier for fabricating solid-shear thickening fluid composites.

Applications

Applications for shear thickening fluids incorporated into pads for sports equipment. Bicycle, motorcycle helmet, construction hardhat and the like which incorporates padded regions between the outer shell and the wearers head containing shear thickening fluids either in packets, impregnated in foams, existing as discrete droplets or stripes or layers within an elastomer, or as part of a co-continuous or interpenetrating network of shear thickening fluid network within a solid plastic or elastomeric material.

A mouthgard fabricated from a conformable polymer or elastomer containing discrete or co-continuous regions of shear thickening fluids would likely exhibit improved energy dissipation. Such an article could reduce the likelihood of concussion, dental damage, etc.

Conformable Pads incorporating discrete regions, dispersed droplets, co-continuous networks of shear thickening fluids within a solid polymeric or elastomeric second material could be incorporated into gloves that can serve to reduce vibration or protect the hands from a jarring impact. One possible application would be the wrist protection guards worn during roller skating and roller blading. Additionally, such conformable padding could be used to generate knee pads, elbow pads and the like for providing improved safety from impact to specific regions.

A conformable cast material can be fabricated from the polymeric or elastomeric-shear thickening fluid composites containing discrete droplets, or co-continuous regions of shear thickening fluids. Such materials could provide improved protection by limiting movement (twisting, bending) of a broken bone, muscle strain, sprains, or injured limb (wrist, elbow, ankle, knee, neck, spine or the like. Such a material could also be used as a cast material worn while strains and sprains are healing similar to air casts to the ankle, wrist or the like which allows movement but protects against rapid twisting or impacts which could re-injure the region.

The novel conformable composite comprised of discrete droplets, or co-continuous networks of shear thickening fluids could be used in seat cushioning and neck supports in automobiles, airplanes, trains and the like to provide more protection during accidents. This would be particularly beneficial for protecting the spine and neck from injury such as from torque or whiplash.

Pads fabricated of conformable and resilient composites containing shear thickening fluids as discrete droplets or co-continuous networks within a plastic or elastomer second material could be positioned at high stress and/or frequently impacted regions such as beneath the heel and beneath the ball of the foot. The nature of the fluid within these types of pads could also be a large pocket of fluid directly local to the point of impact or potential point of impact. These pads could be incorporated directly into a sports shoe design or as part of a shoe insert to reduce impact during walking, running, jumping and the like. A potential energy dissipative construction for an athletic shoe would allow shear thickening fluid to pass through channels connecting pockets located beneath the ball of the foot and heel, allowing transfer of shear thickening fluid between both impact regions as a result of the natural heel-to-toe weight transfer associated with walking, running and the like.

Mechanical components could be fabricated from solid materials containing shear thickening fluids as discrete droplets or regions or as a co-continuous network within the solid material. Smart components could be fabricated where the stiffness or hardness of a flexible component can change as a result of degree of deformation, such as from elongation, bending, torque, twisting, compression, or dependent on the rate of elongation, bending, torque, twisting, compression. Such components could have utility as part of a suspension which could stiffen in response to bending, etc.

The novel blends of shear thickening fluids and a second liquid material discussed earlier could have utility in several applications used as a medium to control mechanical actuation of one object relative to another. This material could be used as a shock absorbing medium, such as within the rotary shock absorber discussed by Hesse, U.S. Pat. No. 4,503,952, the viscoelastic damper discussed by Seshimo (U.S. Pat. No. 4,759,428), or the tug resistant link discussed by McMahon et al. (U.S. Pat. No. 5,712,011). Additionally, the novel energy dissipative blend could be used to control, attenuate, or facilitate the transfer of energy between two or more objects such as that associated with torque, translation and vibration. These novel composites could be used in hard drive and CD drive vibration or shock dissipation, or to protect from impact sensitive mechanical, electrical, or optical equipment.

### BRIEF DESCRIPTION OF THE FIGURES

FIG. 1 illustrates a Pictorial Representation of Emulsion Under Study With Shear Thickening Fluid as Discrete Phase.

### EMULSION PREPARATION

The first part of the two-part emulsion is a shear thickening fluid (STF) which comprises polyethylene glycol and silica particles. The fluid was prepared using amorphous silica powder with an average particle diameter of 450 nm (Nippon Shokubai KE-P50) dispersed in 200 MW Polyethylene Glycol (Clarient PEG-200), Table 1. The silica particles were first added to PEG at a weight fraction of 30% with the diluteness of the system aiding in particle dispersion. This mixture was then centrifuged for 2 hours and the supernatant removed, leaving a cake of close packed silica particles (Φ˜64%). Very small amounts of PEG were added to the silica particles until the mixture reached the desired flow properties, higher additions of PEG at this stage would decrease the viscosity of the solution. Thermogravimetric analysis was conducted on the sample to determine the weight fraction of particles in this final solution, 59.52%, which was then used to determine the volume fraction of silica in PEG. All emulsions were formulated with the same 49 vol % silica shear thickening fluid.

TABLE 1
1. Material Properties

| | ρ (g/cm3) | η₀ (Pa-s) |
|---|---|---|
| Silica | 2.055 | — |
| PEG | 1.02 | 0.057 |
| Silicone Part A | 1.12 | 21.4 |

The second part was a silicone oil, acquired from GE Silicones (SLE5700-D1), and was chosen for its Newtonian viscosity behavior and high immiscibility in PEG. For the rheological testing only Part A of the two part polymerizable silicone was used. The silicone can be polymerized with the addition of the catalyzing agent, Part B.

The emulsions were prepared by weighing out a specific mass of each fluid in a 20 mL glass scintillation vial and then mixing by hand with a spatula. The samples studied in this paper are given in Table 2, with a wide compositional range. In this paper the samples will be referenced by the volume fraction of shear thickening fluid contained, Φ_{STF}.

TABLE 2
2. Emulsion Compositions

| Mass of Shear | | | |
|---|---|---|---|
| Thickening Fluid | Mass of Silicone | Weight % | |
| (gm) | (gm) | STF | Φ_{STF} |
| 3.042 | 0.379 | 88.9 | 82.9 |
| 2.2796 | 0.7922 | 74.2 | 63.4 |
| 1.721 | 0.809 | 68.0 | 56.2 |
| 3.904 | 3.915 | 49.9 | 37.5 |
| 1.938 | 5.946 | 24.6 | 16.4 |
| 0.7048 | 3.6701 | 16.1 | 10.4 |

The two components were mixed by hand and a sample of this emulsion plated onto a glass slide for inspection under an optical microscope, representative images are shown in FIGS. 2a and b. It was suspected that the absence of a mechanical mixer would create a very polydisperse droplet size due to the non-uniform power input (Kitade, S., Ichikawa, A., Imura, N., Takahashi, Y., Noda, I., “Rheological properties and domain structures of immiscible polymer blends under steady and oscillatory shear flows,” J. Rheol. 41(5), 1039-1060 (1997)). Visual confirmation of the formation of two distinct phases enabled sizing of the disperse phase. The droplet size of the disperse phase as prepared was found to range between ˜1 and 100 μm.

A 25 mm cone and plate geometry (gap=0.0509 mm, angle=0.099 radians) was utilized on a strain-controlled rheometer (Rheometrics SR-5000) to determine the rheological properties of each emulsion and the pure components. Testing was performed at a constant 25° C. with a peltier and constant temperature water bath used for temperature control. The samples were subjected to a uniform force gap testing followed by a creep test at 5 Pa until the viscosity of the sample reached a steady state, approximately two minutes. This was done to insure homogeneity of the sample and to set a fixed shear history for each test. This constant preshear should result in an emulsion morphology at steady state as a balance between droplet breakup and coalescence. Stress sweeps were run on the rheometer with a maximum time of 30 seconds per data point and frequency sweeps were run without a time limitation for each data point. After completion of the rheological tests a portion of the used sample was then plated for observation under the optical microscope. The quick relaxation time of the sample made quantitative analysis of samples plated after testing in the rheometer inaccurate, as the system relaxed before the phase microstructure could be analyzed. The measurements, however, helped in qualitative understanding the effects of shear flow on the sample morphology.

Due to the unknown phase structure of the system under various levels of shear it seems useful to incorporate optical techniques. There were limitation to the study of this due to equipment and sample selection. An ARES Rheometer (Rheometrics INC) with flow birefringence setup was used.

A simple shear cell was constructed by inserting sample between two glass microscope slides. The slides could then be sheared with respect to each other and the resulting fluid behavior observed under an optical microscope with image capturing software.

An optical microscope with a digital camera was used to capture the phases of the emulsion. Samples were plated on glass microscope slides and the view field could be magnified up to 1000×.

The flow behavior of the concentrated colloidal suspension of 49 vol % silica in PEG is shown in FIG. 3a (ascending stress sweep). The discontinuous shear thickening response is clearly seen and it should be noted that this response is fully reversible with no hysteresis. The stress profile is also given, displaying the stress controlled viscosity jump.

The Newtonian viscosity behavior of the silicone oil used is shown in FIG. 3b (ascending stress sweep). The constant viscosity as a function of shear rate, for both forward and reverse flow, was chosen so that the distinctly rich non-Newtonian behavior of the shear thickening fluid would be recognizable in the emulsion phase. The decrease in viscosity seen in FIG. 3b at high shear rate is attributable to formation of secondary flows in the mixture at such high shear rate.

The results of small angle oscillatory shear measurements at 5 Pa are shown in FIG. 4. In the terminal region, low frequency limit, the loss modulus of each the silicone and shear thickening fluid increases linearly with the frequency and the storage modulus with the frequency squared. The graph also displays the drastically different relaxation times of the two components, with the silicone relaxing much faster than the STF.

A more complete analysis of the shear thickening phenomenon for systems very similar to the one studied is given by Lee and Wagner (Lee, Y. S., Wagner, N. J., “Dynamic properties of shear thickening colloidal suspensions,” Rheol Acta 42,199-208 (2003)) and the interested reader is referred to that manuscript for a thorough explanation of STF rheological behavior.

The viscosity as a function of both strain rate and stress for the emulsions are shown in FIGS. 5a and 5b respectively (forward sweep shown). As can be seen the viscosity of the emulsion is highly dependent on the volume fraction of shear thickening fluid in the mixture and the shear stress imparted.

Viscosity-Stress Profile of Samples

The viscosity of each emulsion is a nontrivial combination of the pure component curves. At low shear thickening fluid volume fractions, the samples display Newtonian like fluid behavior at low stresses and a very small shear thinning region. At higher STF loadings the low shear behavior more closely tracks that of the STF. The emulsions with the highest volume fractions of shear thickening fluid (Φ_{STF}=82.9, 63.4, 56.2) also exhibit discontinuous shear thickening at increasingly higher stress levels while the lower volume samples exhibit shear thickening followed by a plateau and then a second shear thinning region (FIG. 6).

The critical stress for shear thickening is defined as the stress at the minimum in the viscosity vs. shear stress curve at the onset of shear thickening. This is plotted against Φ_{STF} in FIG. 7 for ascending stress sweeps. Clearly, the stress required for shear thickening is highest at low STF loadings.

The time dependence of the samples was studied through a constant ramp of the stress up to the plateau point and back. All stress sweep testing was performed with data collection at a thirty second maximum for each data point with the reverse sweep immediately following the forward progression. This was chosen to identify possible shear rate effects on sample morphology. FIG. 8 shows the viscosity jump from the forward to reverse sweep. The discontinuously shear thickening sample exhibits no signs of hysteresis, whereas the sample that was previously shown in FIG. 6 to have a second shear thinning region exhibits significant thixotropy. The emulsion with the lowest STF loading exhibited a similar trend but with a much lower level of hysteresis. Such hysteresis is a sign of shear sensitivity of the microstructure.

The viscosity-concentration relationship of the mixtures was determined by taking the viscosity of each component at constant stress values. This relationship is shown in FIG. 9. Once again a behavioral difference is seen as the volume fraction of shear thickening fluid is increased. At low STF loadings the effects of shear stress are minimal, whereas at higher STF loadings, the nonlinear dependence of the STF component is evident in the emulsion viscosity.

Dynamic tests were run for all samples at both one and five radians per second so that the linear viscoelastic region could be determined. FIGS. 10 a,b show the elastic and loss modulus for the samples at a constant frequency of 1 r/s while FIGS. 11 a,b show the values at 5 r/s. The low STF loading samples show minimal effects of increasing stress amplitudes, whereas the high STF loading emulsions show non-linear behavior typical for the STF component (Lee, Y. S., Wagner, N. J., “Dynamic properties of shear thickening colloidal suspensions,” Rheol Acta 42,199-208 (2003)). There are seemingly few differences between the responses of the mixtures at the two different frequencies tested. The viscous contribution is seen to be an order of magnitude greater at the high frequency where as the elastic contribution is on the same order for both frequencies.

The frequency sweeps, performed at a stress of 5 Pa, are shown in FIG. 12a. The terminal region of each curve is very similar to the pure component curves shown earlier and allows no additional insight into possible structures formed to this point. Cavallo, R., Guido, S., Simeone, M., “Drop deformation under small-amplitude oscillatory shear flow,” Rheol Acta 42, 1-9 (2003) found dynamic tests to be a sensitive, non-disturbing probe of the microstructure of liquid-liquid systems. The phase angle plots for each system are given in FIG. 12b, where

$$tan ( δ ) = \frac{{G}^{″}}{{G}^{′}} .$$

Optical Microscopy

Phase Distinction and Shear Cell

The samples were viewed to determine the continuous and discrete phases formed in emulsions with varied shear thickening fluid compositions. As was shown in FIGS. 2a and 2b it was possible to create discrete phases of each component in a continuous phase of the other. The emulsions created were too opaque and attempts to measure the flow dichroism failed. An analysis of the response of the emulsions to shear was performed using the shear cell constructed of glass slides. A small amount of sample was plated between two glass slides allowing shear of the sample by movement of either slide while fixing the other. The shearing between plates was done by hand (as a motor was unavailable). The setup permits one to view in a direction perpendicular to the flow field. Results from the constructed shear cell were problematic due to the slow frame capture speed of the camera (1 frame per second). This prevented quantitative analysis of the droplet behavior. The capture speed and resolution of the camera were also prohibitive toward study of any structural change under high shear.

FIG. 13a shows a sample with Φ_{STF}=63.4 under a stress that is not known, an arrow is added to indicate the direction of shear. What can be seen is the elongation of the silicone droplets under this shearing action. FIG. 13b shows this same sample at rest and again under shear.

Droplet Relaxation Study

A sample consisting mostly of shear thickening fluid, Φ_{STF}=63.4, was plated on top of a single glass slide (no cover) and subjected to a shear stress at t<0. Once the stress was removed the state of the system was recorded using image-capturing software on the microscope. This is shown in FIG. 14, with silicone occupying the discrete regions in a continuous shear thickening fluid matrix. The time stamps of when the pictures were taken are given and could be used to calculate the surface tension between the phases. Evident from the slides is the elongation of the discrete phases of silicone and the subsequent relaxation back into a spherical shape. Some of the elongated threads are observed to break into droplets. This overall behavior is expected as a lower energy state is reached with a decreased interfacial area and is in agreement with the predictions of Edwards, B. J., Dressler, M., “A rheological model with constant approximate volume for immiscible blends of ellipsoidal droplets,” Rheol. Acta 42, 326-337 (2003).

The rheological behavior of the emulsions is interesting as discrete phases of a shear thickening fluid are shown to influence the flow properties of a Newtonian fluid matrix at low concentrations of shear thickening fluid. The nature of the experimental method does not allow for visual confirmation of microstructure under shear, as would be possible in a glass Couette cell (Rusu, D., Peuvrel-Disdier, E., “In situ characterization by small angle light scattering of the shear-induced coalescence mechanisms in immiscible polymer blends,” J. Rheol. 43(6), 1391-1409 (1999)). However, through simple analysis of the rheological behavior and pictures of the system at steady state an understanding of the structure and continuity of the system can be developed. Analysis can begin keeping in mind the key results of FIGS. 2a and 2b. FIG. 2a shows that when small amounts of silicone are added to the shear thickening fluid discrete regions of silicone are formed. The same is true for small amounts of shear thickening fluid added to silicone, FIG. 2b. It is then hypothesized that there is a phase inversion between a continuous phase of shear thickening fluid and a continuous phase of silicone at some intermediate volume fraction of shear thickening fluid.

Shear Thickening Behavior

Shear Testing

FIG. 5a displayed the viscosity stress relationships of the emulsions tested and an enlarged critical stress region is shown in FIG. 15. The magnification clearly shows the shear thickening behavior for each emulsion tested with flow curve characteristics dependent on volume fraction of shear thickening fluid.

The discontinuous shear thickening observed in pure shear thickening fluid is also observed in the samples with a volume fraction of fifty-six percent shear thickening fluid. As the amount of shear thickening fluid decreases, the behavior changes as the fluids display a shear thickening transition followed by a second region of shear thinning at higher shear rates, FIG. 6. These results partially confirm the hypothesis that samples with shear thickening fluid in the continuous phase will exhibit discontinuous shear thickening while samples with shear thickening fluid in the discrete phase will not. This will be discussed in greater detail later. It is also evident that there is a different response for emulsions around the region where shear thickening fluid is half of the mixture by mass (Φ_{STF}=37.5). Also apparent is the change in shear thinning behavior for samples as the volume of shear thickening fluid is lowered, from a very steep and drastic shear thinning regime to a flatter, more Newtonian like fluid behavior.

Dynamic Rheological Testing

The dynamic rheological testing of the emulsion can also be used to extract behavior differences between samples. Analysis of the loss modulus shown in FIG. 11b shows that for the samples with Φ_{STF}>37.5 there is a very steep shear thickening transition with increasing stress amplitude. In the sample where Φ_{STF}≦37.5 the shear thickening response is characteristically different and subdued from the pure shear thickening fluid. This response difference suggests that when that sample is at rest, as in small amplitude dynamic testing, the shear thickening response is different from the response under steady shear. The shear thickening response in the shear testing is more apparent for the low volume (Φ_{STF}=16.4, 10.4) shear thickening fluid samples than in the dynamic testing where the low volume fraction samples more closely resemble the pure silicone oil sample. This suggests the shearing of the sample affects the microstructure of the sample. A more in depth discussion of the dynamic properties of the shear thickening fluid response can be found in work done by Lee and Wagner (Lee, Y. S., Wagner, N. J., “Dynamic properties of shear thickening colloidal suspensions,” Rheol Acta 42,199-208 (2003)).

Cross Model

The Cross model for colloidal suspensions, Equation 1, was used to model the viscosity curves as a function of shear rate with b and m as variable parameters. The model was used to determine the zero shear, η₀, and infinite shear viscosities, η_{∞}, of the emulsions.

$$\frac{η - {η}_{∞}}{{η}_{0} - {η}_{∞}} = \frac{1}{1 + {( b \dot{γ} )}^{m}} \qquad ( 1 )$$

When fitting the samples that shear thickened, the data was truncated to include only the points before the sample began to thicken. The data is shown with the fitted lines in FIG. 16 with model parameters given in Table 3. As the silicone oil is Newtonian, it is not fit.

TABLE 3
3. Cross Model Fit Parameters

| | Φ_{STF} | | | | | | |
|---|---|---|---|---|---|---|---|
| | 100 | 82.9 | 56.2 | 37.5 | 16.4 | 10.4 | 0 |
| b (s) | 6782.6 | 68069.9 | 61.5 | 4.91 | 1.14 | 3.33 | 0 |
| m | 0.74 | 0.62 | 0.89 | 0.88 | 0.76 | 1.27 | 0 |
| η_{∞} (Pa-s) | 0.5 | 0.5 | 9.07 | 35.99 | 27.82 | 28.83 | 24.2 |
| η₀ (Pa-s) | 7236.2 | 45305 | 342 | 119.4 | 47.95 | 40.22 | 24.2 |

FIG. 17 shows the result of the modeled samples reduced to a single line. This reduction shows the similar behavior of all the fluids.

Viscosity Behavior

If one begins with a pure fluid and begins to add small amounts of another immiscible fluid to the fluid matrix in the form of droplets, the zero shear rate viscosity of the mixture would theoretically follow the viscosity behavior of the Einstein model (Einstein, A. “Eine neue Bestimmung der Molekuldimensionen” Ann Phys 19, 289-306 (1906)). This was derived for suspension of hard, spherical particles with no slip boundary conditions and so it would be expected to hold if the droplet phase were spherical and rigid relative to the matrix. The model is given in Equation 2 where φ is the volume fraction of dispersed phase, μ the viscosity of the pure component fluid, and η the intrinsic viscosity of the resulting suspension.
η=μ[1+2.5φ] (2)

This equation was developed for spheres added to a Newtonian fluid, however if it is extrapolated for use in this system the results are interesting and will be discussed shortly. Two other models that are commonly used to describe polymer blend systems are the log-additivity rule, Equation 3, and the fluidity model, Equation 3b. In this rule η_{b} represents the blend viscosity, Φᵢ the volume fraction of component i, and ηᵢ the viscosity of component i.
log(η_{b})=Σφᵢlog(ηᵢ) (3a)

$$\frac{1}{{η}_{b}} = \sum \frac{{ϕ}_{i}}{{η}_{i}} \qquad ( 3 b )$$

The zero shear viscosities calculated from the Cross Model fits are shown in FIG. 18 along with the viscosity calculated from Equations 2 and 3.

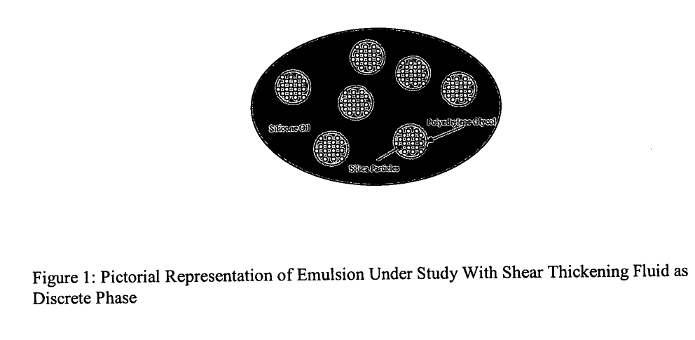

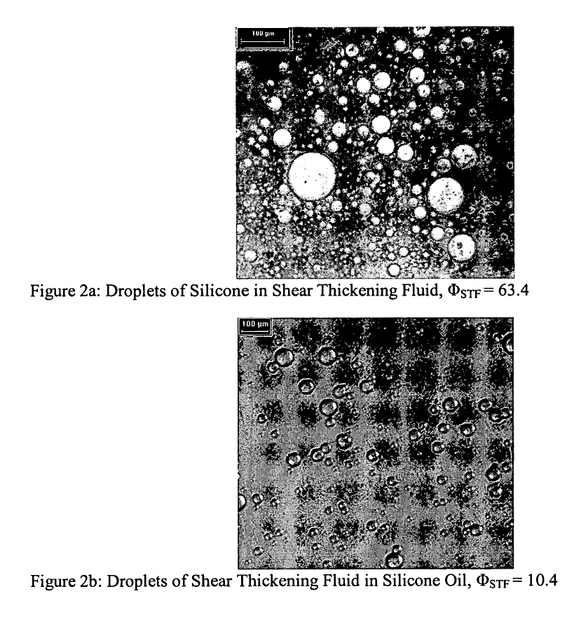

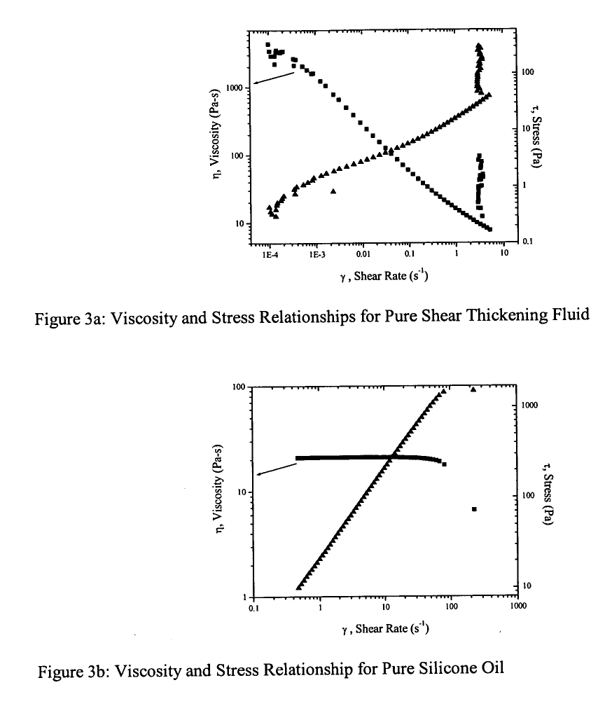

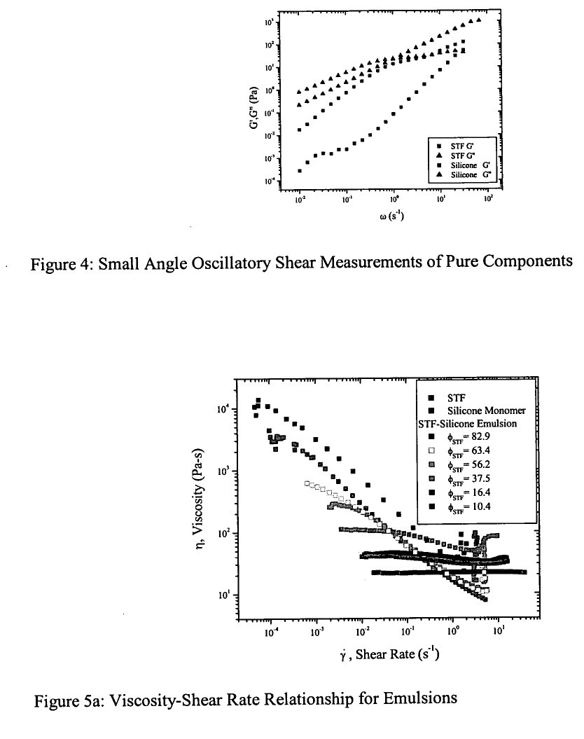

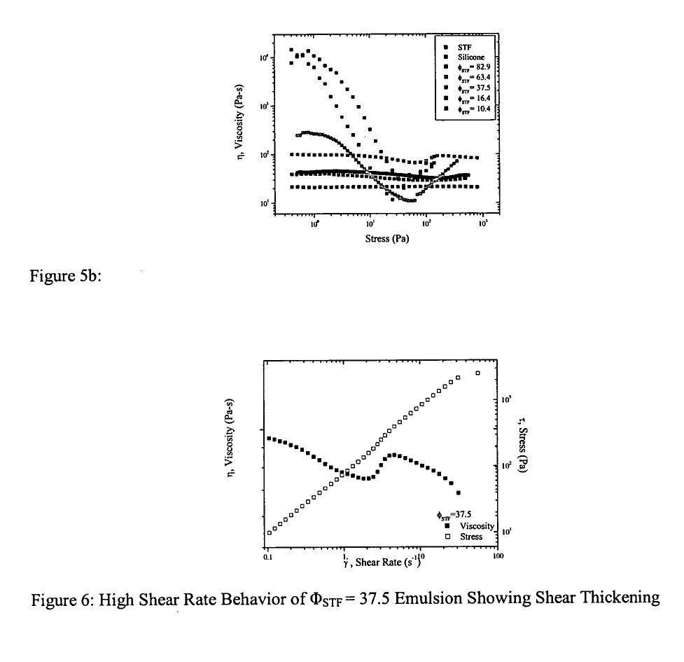

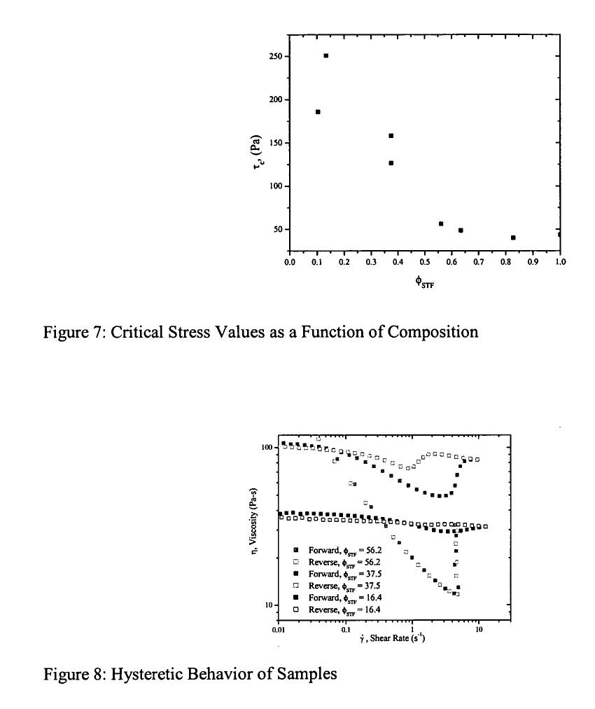

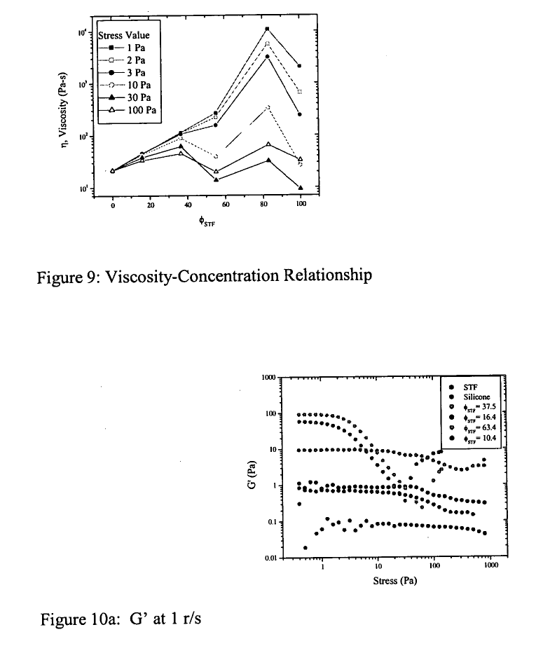

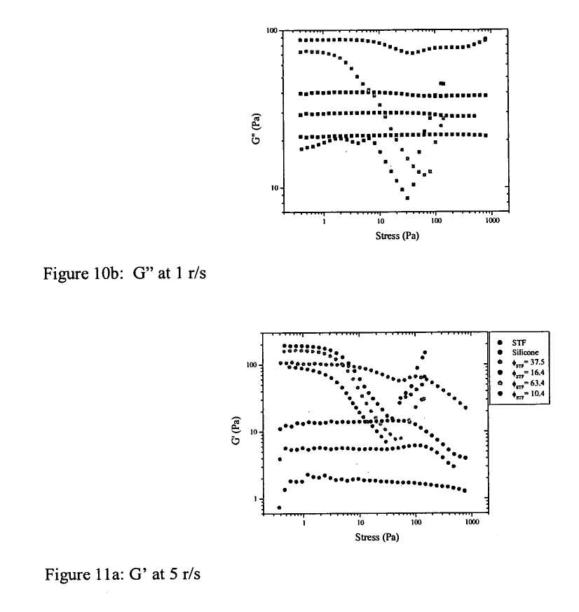

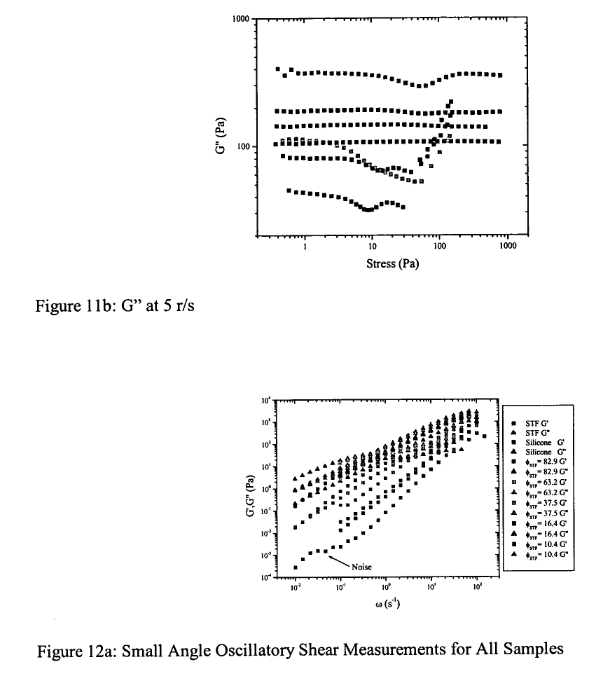

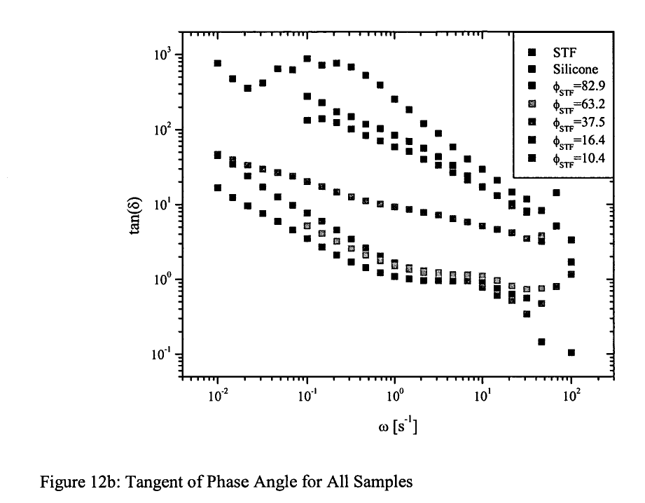

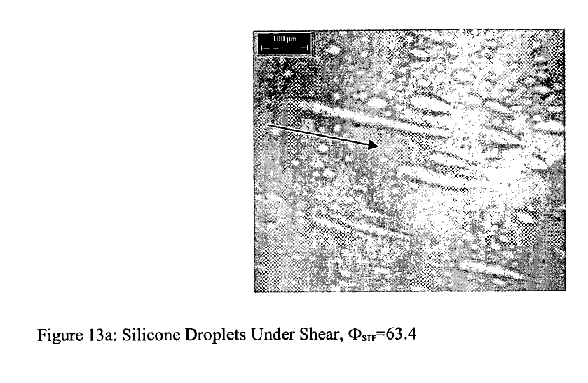

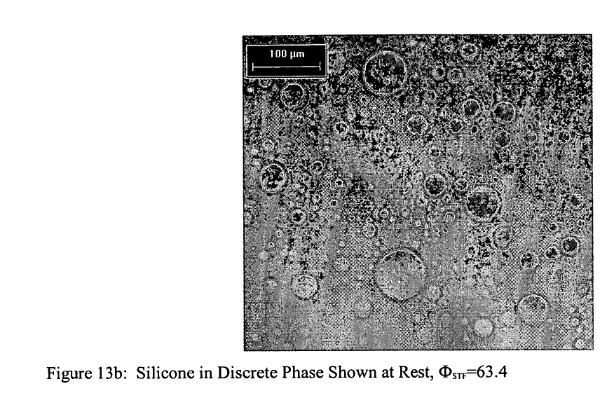

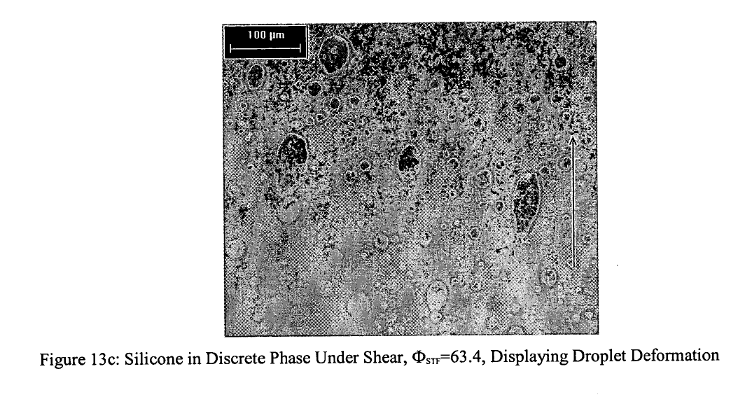

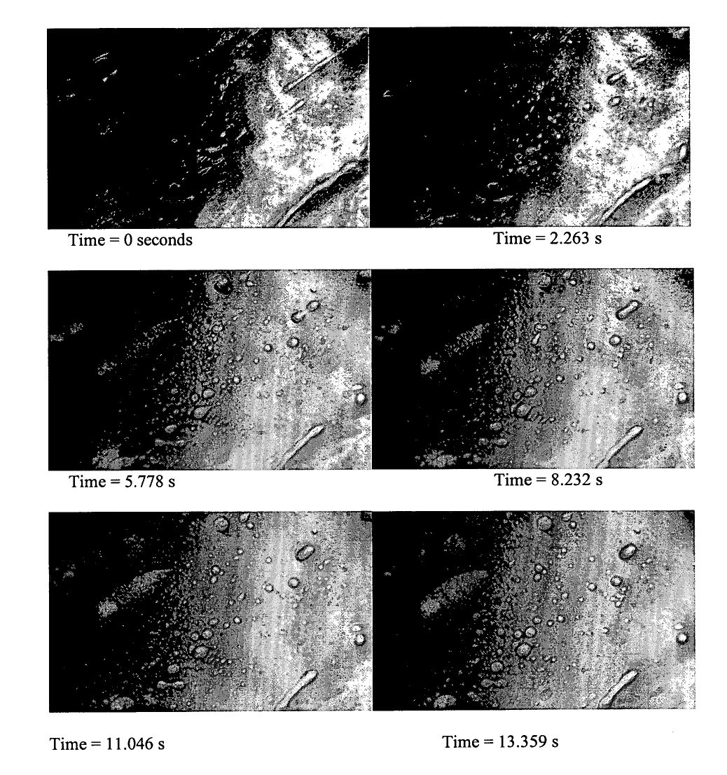

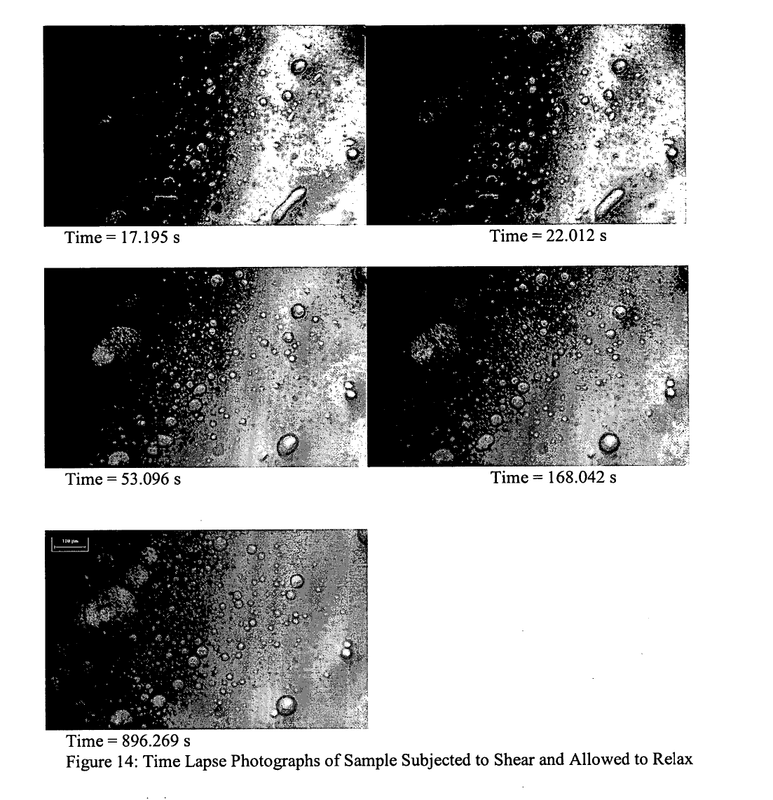

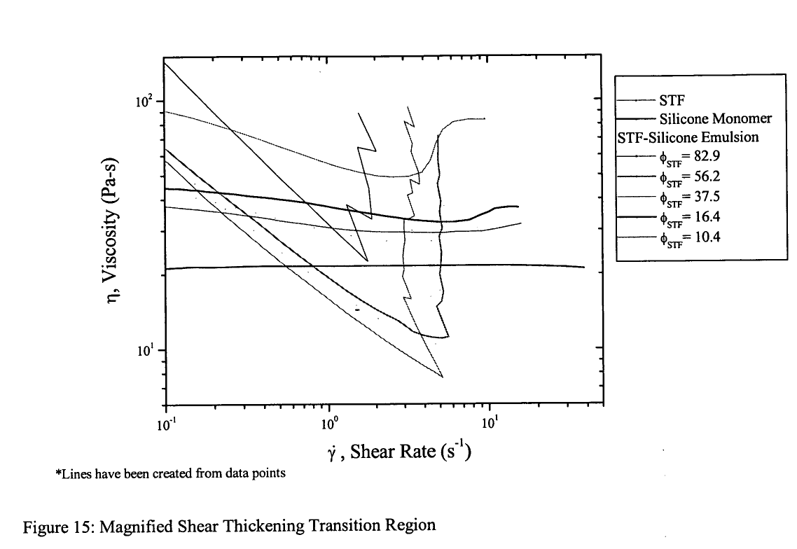

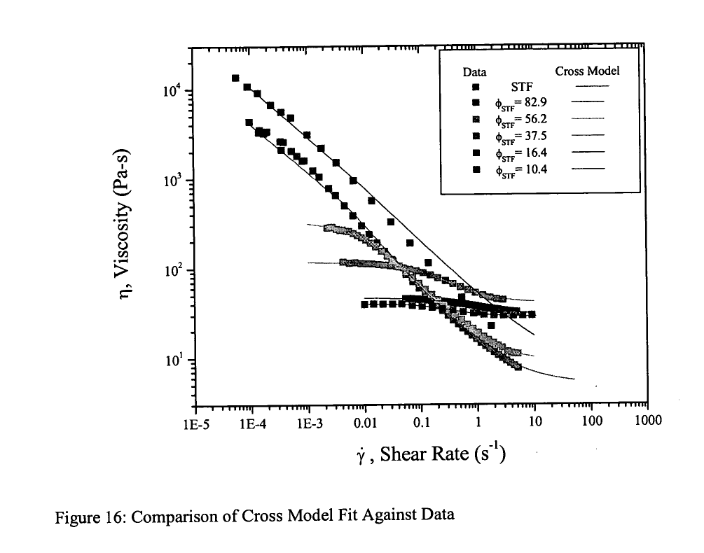

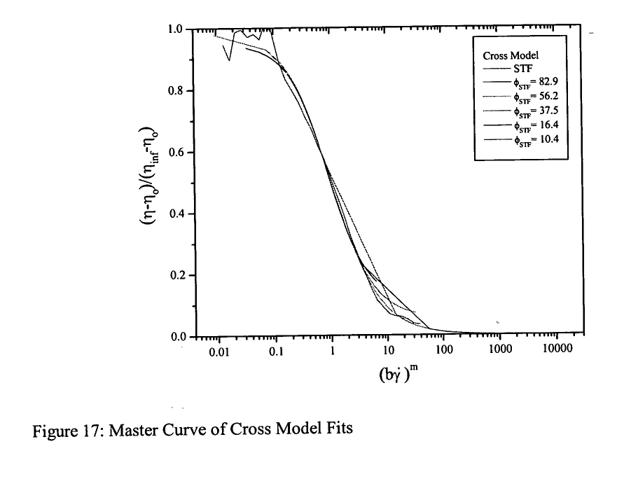

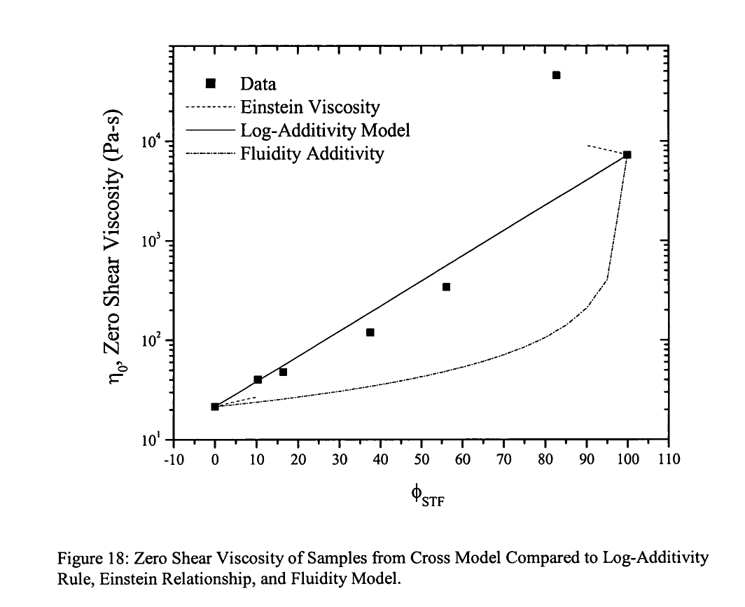

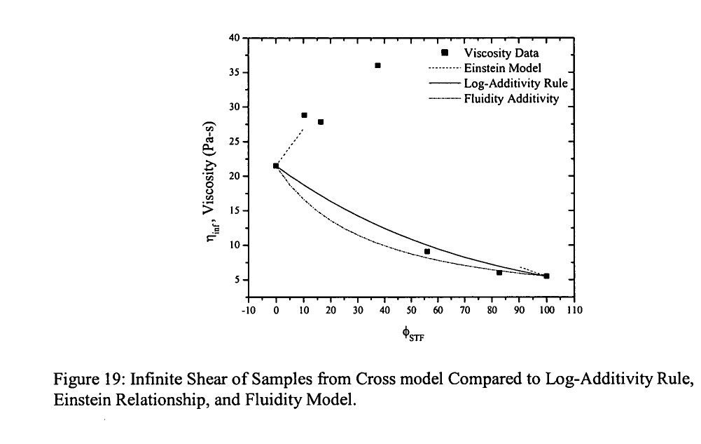

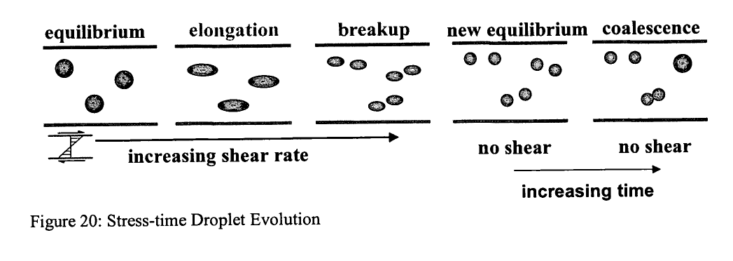

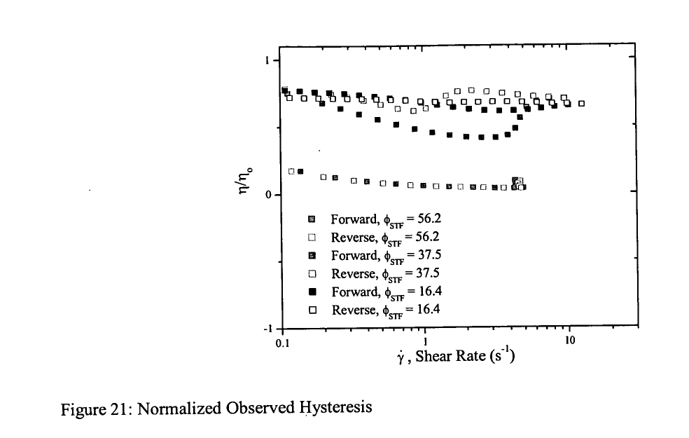

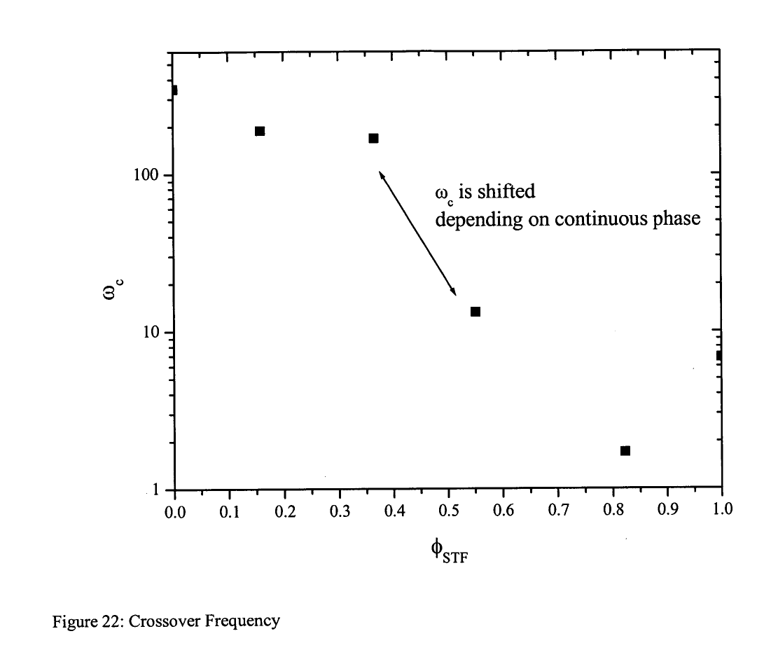

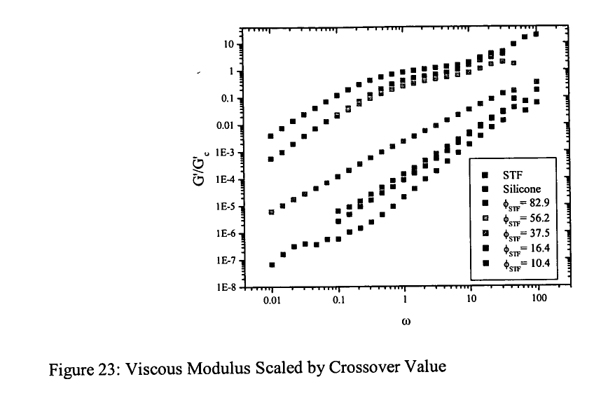

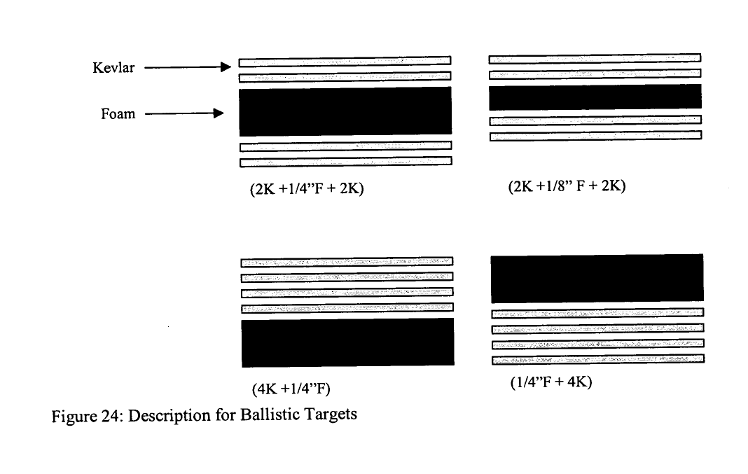

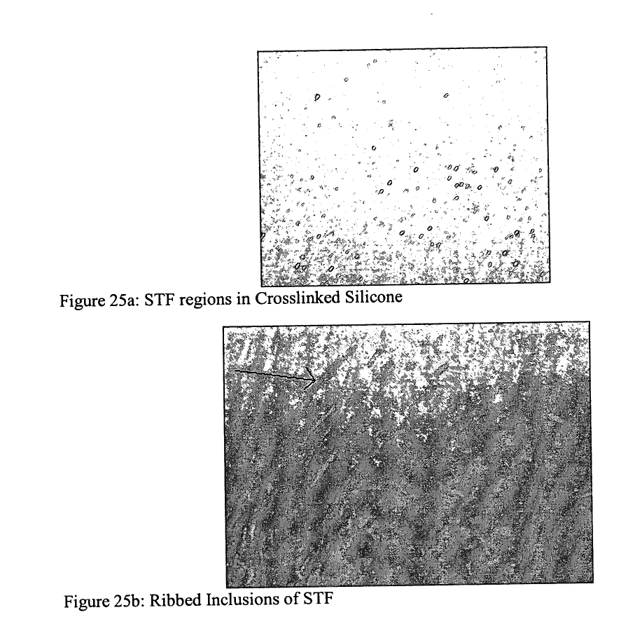

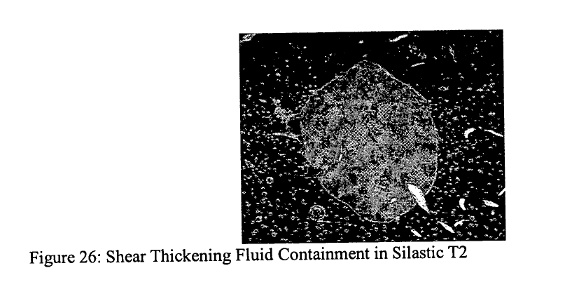

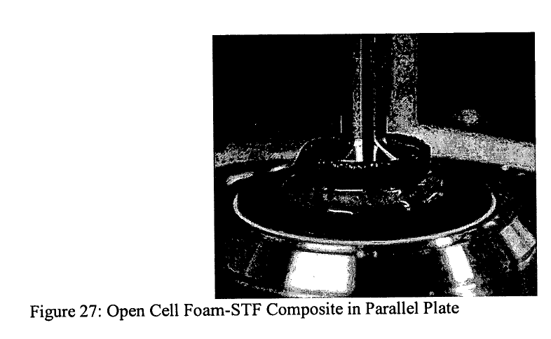

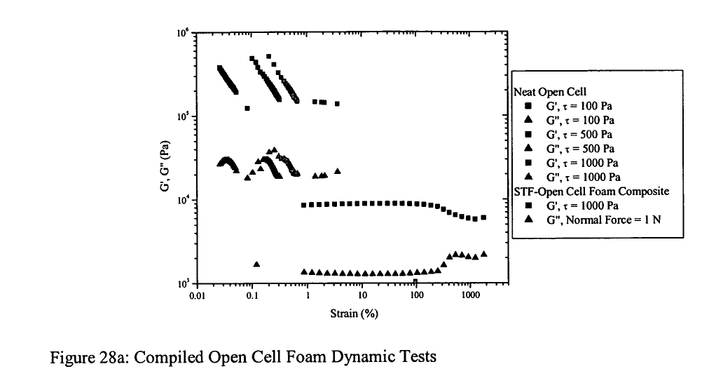

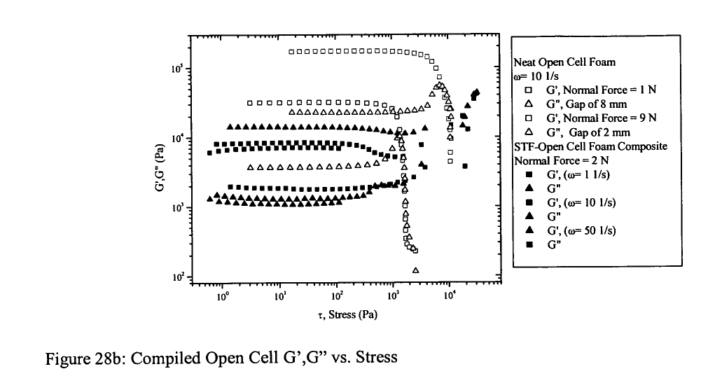

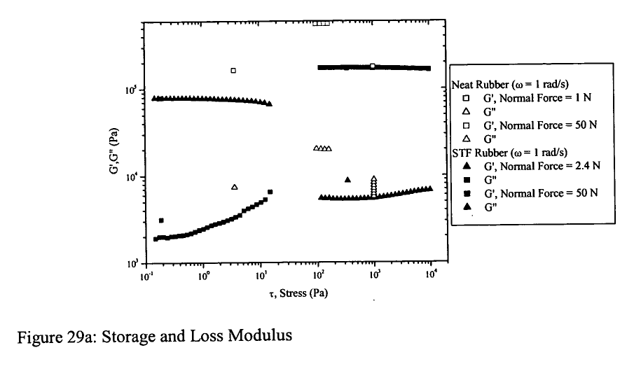

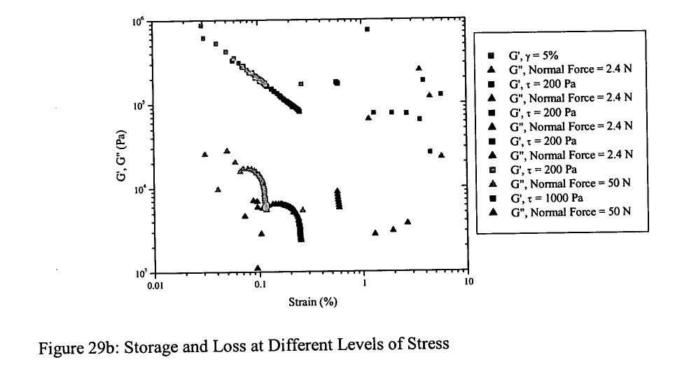

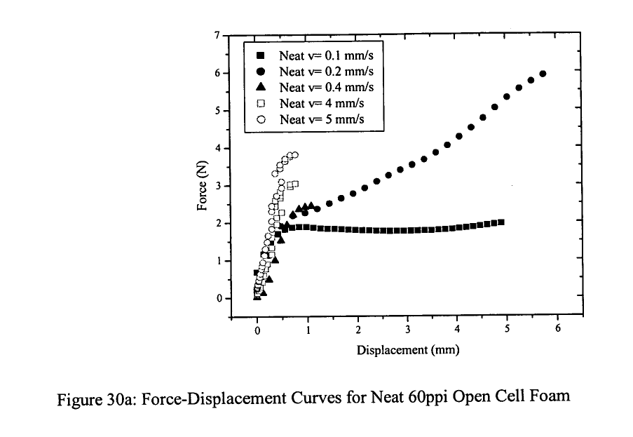

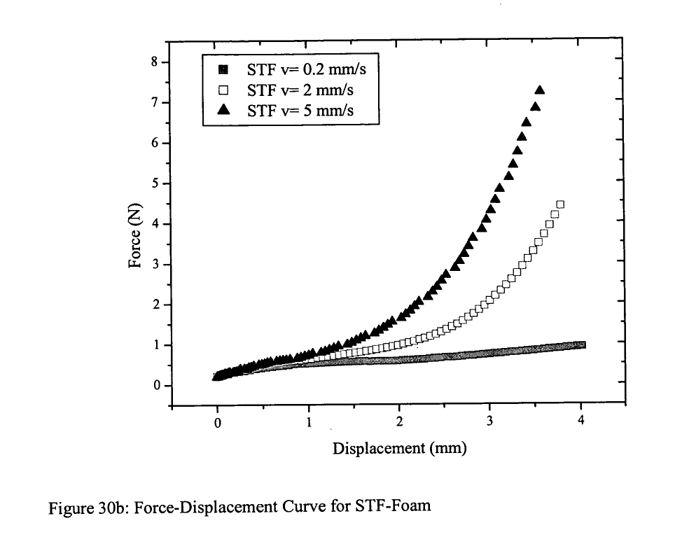

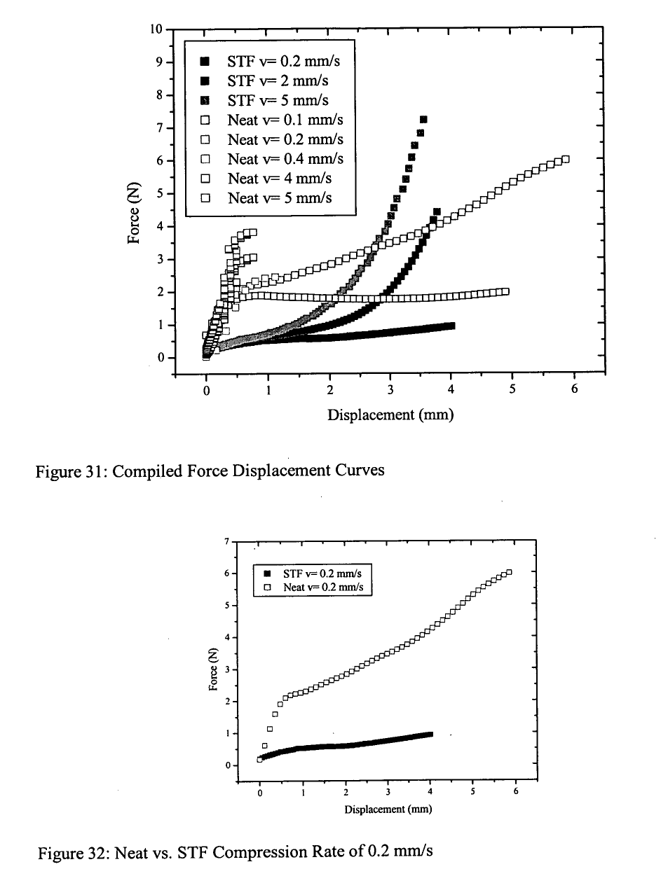

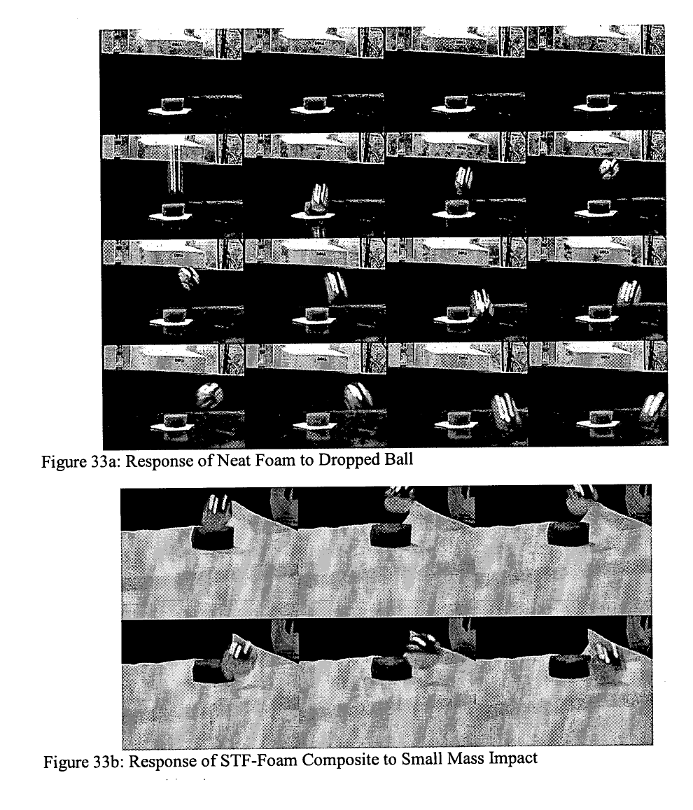

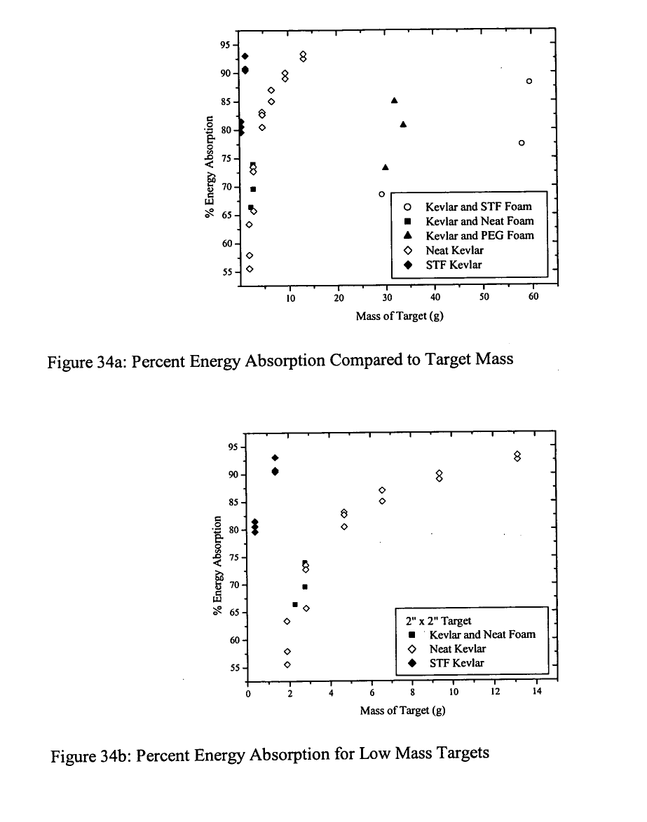

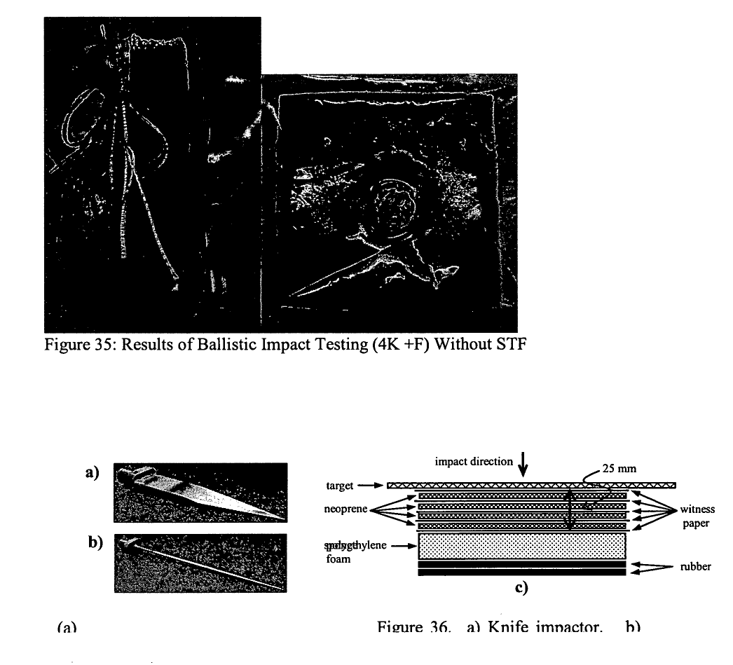

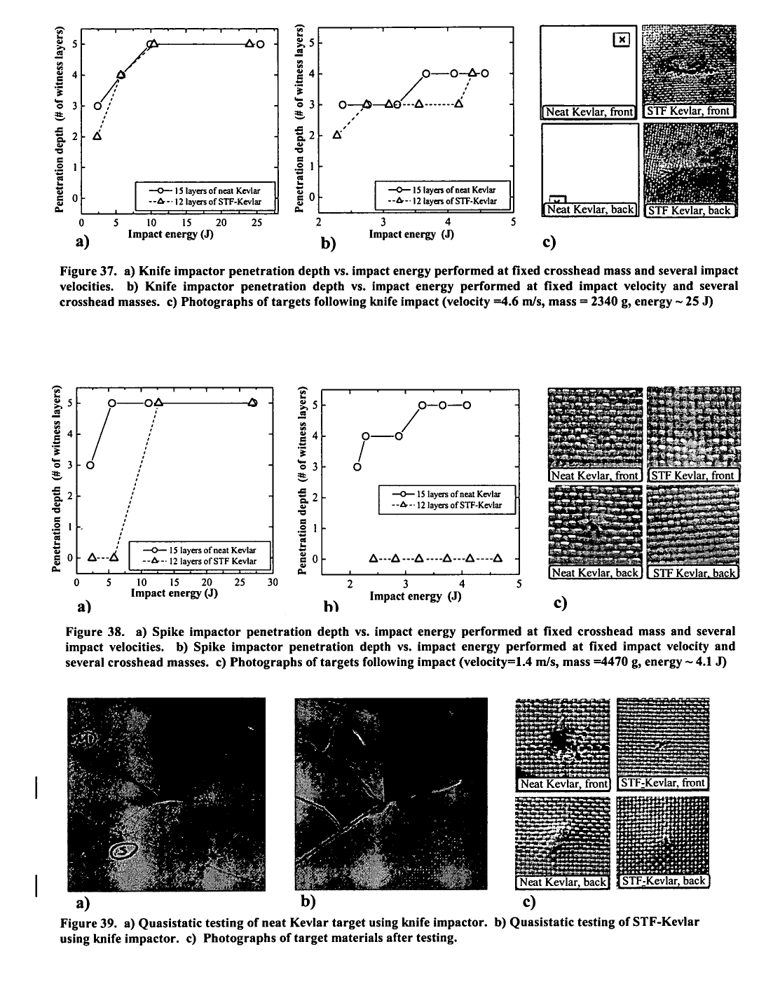

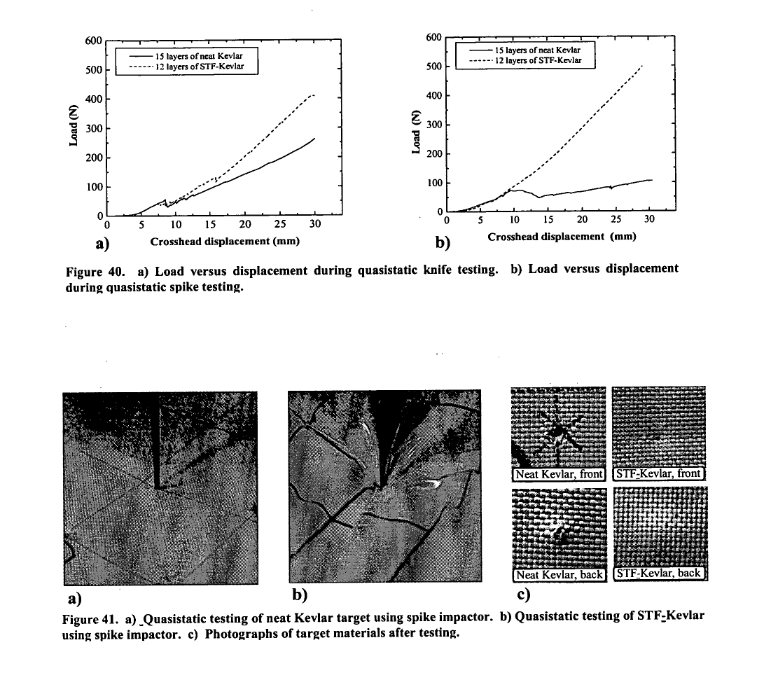

The Einstein relationship underpredicts the zero shear rate viscosity rise of shear thickening fluid droplets added to the silicone matrix (Φ_{STF} approaches 0). This is expected because of the visual confirmation of discrete phase droplets shown in FIG. 1b and the high intrinsic viscosity ratio (λ=300). One expects the viscosity values to deviate from the Einstein predictions at volume fractions greater than ˜5%. If the opposite is analyzed and small amounts of silicone are added to a pure shear thickening fluid the zero shear rate viscosity is again found to be higher than that of the pure fluid. This time the increase greatly exceeds the Einstein prediction, though one would not expect the addition of drops of a Newtonian fluid into a non-Newtonian fluid to follow these predictions. Furthermore, the high zero shear viscosities are extrapolated and subject to error. What is interesting is the non-monotonic increase in viscosity as the volume fraction of shear thickening fluid is added.

The Fluidity model was found to under predict the viscosity at all volume fractions. As discussed earlier the log additivity rule is used as a classification tool (Utracki, L. A., “On the viscosity-concentration dependence of immiscible polymer blends,” J. Rheol 35(8), 1615-1637 (1991)), (Zhao, J., Mascia, L., Nassehi, V., “Simulation of the Rheological Behavior of Polymer Blends by Finite Element Analysis,” Adv. Polymer Tech. 16(3), (1997)), with this system showing both positive and negative deviation from the rule (PNDB). This classification is usually associated with blends that have a phase inversion (Zhao, J., Mascia, L., Nassehi, V., “Simulation of the Rheological Behavior of Polymer Blends by Finite Element Analysis,” Adv. Polymer Tech. 16(3), (1997)), suggesting corroboration of the earlier hypothesis that a phase inversion was present. The system follows the log additivity model for volume fractions of STF up to 10%. The positive deviations from the log additivity model are observed when the silicone is in the dispersed phase.

The viscosity at an infinite shear rate was extrapolated using the Cross model, without inclusion of shear thickening points, and is shown in FIG. 19 along with Einstein behavior predictions and the mixing rules given in Equation 3. When the log additivity rule is applied to the infinite shear viscosity the blend once again exhibits positive and negative deviations, however, at the high shear rate the positive deviations come at low shear thickening fluid concentrations and the negative deviations at high concentration. At low volume fractions of shear thickening fluid, with STF in discrete phase, the viscosity behavior appears to follow Einstein expectations. This could be due to the droplets of STF being above the critical stress and acting as hard spheres. This does not hold for the contrary where low volumes of silicone are present, here the Einstein and Log-Additivity over predict the viscosity. In the region of high volume fraction of shear thickening fluid the infinite shear viscosity follows the fluidity model very well.

Another interesting result of the infinite shear viscosity is the drop off in the region where the volume fraction of shear thickening fluid is ˜50. This dramatic decrease in viscosity for the high Φ_{STF} samples is due to the sharp shear thinning region. This also suggests a difference in the structure between samples in this region and a possible phase inversion in this region. Interestingly the possible inversion area occurs at a lower volume fraction than that suggested by the results of the zero shear viscosity. However, one must also keep in mind the changes in dimension and geometrical shape associated with high stresses (high shear rates).

Emulsion Morphology

For emulsions with a low volume fraction of shear thickening fluid, Φ_{STF}=10, the silicone is the continuous phase and the shear thickening fluid is dispersed in discrete droplets. Under shear the flow of this emulsion is highly complex, with unknown stress profiles inside the droplets. The shear stress measured on the rheometer is the bulk stress of the fluid, and the relationship between the bulk stress and the droplet stress is unknown. An important concept for understanding the flow field would be a characterization of the droplet break up and coalescence, FIG. 20.

It is hypothesized that the emulsion droplets follow typical behavior under the applied shear stresses such that a dynamic equilibrium will be reached for a given steady flow between droplet breakup and coalescence. That leads to a droplet size distribution proportional to the power input, or applied stress, on the fluid. The higher the stress, the smaller the average droplet becomes, whereas when the applied stress is decreased the droplets coalesce under flow and the average size increases (Wagner et al. Doi-Ohta model for blends AICHE J. 45 (1999)). This becomes complicated by the presence of a shear thickening fluid in the droplet phase, as beyond a certain critical droplet stress the behavior of the STF will transfer from a liquid to solid-like phase. At this critical droplet stress the stress of the bulk phase is hypothesized to be the measured critical stress shown in Table 4.

TABLE 4
Critical Values at Shear Thickening Transition
Point for an Ascending Stress Sweep

| | Critical Rate | Critical Stress | Critical Viscosity |
|---|---|---|---|
| Φ_{STF} | (s⁻¹) | (Pa) | (Pa-s) |
| 100 | 3.583 | 43 | 12.1 |
| 82.9 | 1.777 | 40 | 22.5 |
| 63.4 | 4.647 | 49 | 10.4 |
| 56.2 | 5.095 | 56 | 11.0 |
| 37.5 | 2.576 | 126 | 49.1 |
| 37.5 | 3.554 | 158 | 44.5 |
| 16.4 | 7.633 | 251 | 32.8 |
| 10.4 | 6.297 | 186 | 29.5 |

At first consideration it is expected that the critical droplet stress required to initiate the shear thickening response is equivalent for emulsions of various volume fractions of shear thickening fluid. This would be expected as the shear thickening response is stress controlled. For emulsions with Φ_{STF} of around 65% and higher the critical stress value are equivalent to that of pure component shear thickening fluid. This supports the observation that the shear thickening fluid is the continuous phase at high concentration STF. It is not known, however, if silicone is also co-continuous at any of the volume fractions. It is remarkable that emulsions with lower STF loadings still show a clear signature of shear thickening. At the lowest loadings, the STF phase cannot be co-continuous and yet, a clear transition is evident even if it does not lead to flow jamming and the discontinuous behavior observed for the higher STF loadings. Note that the transition is not evident in the dynamic oscillatory measurements possibly as high enough stresses were not explored. It is very significant that shear thickening is induced in the droplets, as this has never been previously reported.

The contribution of interfacial elasticity on the droplet morphology is also an unknown factor. The droplet-matrix interface takes up stress, and the shape of the droplet also determines the actual shear stress, Equation 4. Where τ_{d} is the stress inside the droplet phase, τᵢ is the stress contribution of the droplet elasticity, and τₘ the stress of the matrix (measured stress).
τₘ=τ_{d}+τᵢ (4)

It is well known that the presence of a dispersed phase introduces an elastic interfacial contribution Cavallo, R., Guido, S., Simeone, M., “Drop deformation under small-amplitude oscillatory shear flow,” Rheol Acta 42, 1-9 (2003) and this is consistent with the rheological results shown in FIGS. 5 and 7.

Hysteresis

The hysteresis of the samples shown in FIG. 8 can now be normalized by the zero shear viscosity determined through the cross model analysis and is shown in FIG. 21. The viscosity difference between forward and reverse stress sweeps is a result of the competition between droplet breakup and coalescence.

Following standard theory of droplet size evolution it is reasonable to assume that the state of the system for a given stress is a function of only the stress, when at steady state. Further an increase in stress would yield a smaller average droplet size. The hysteresis observed on the reverse sweep is present because the rates of droplet coalescence, as the stress levels are decreased, are highly memory dependent. On the reverse sweep the droplets of shear thickening fluid are also hypothesized to be at stress values above their critical stress and therefore in a shear thickened state. It could then be hypothesized that this return from the shear thickened state is the cause of the hysteresis. The cause being that the rate of droplet coalescence in the shear thickened region is much slower than the dominating droplet breakup observed in the forward sweep.

High Shear Behavior

FIG. 6 showed the high shear rate behavior of the emulsions for stresses greater than the critical stress for shear thickening response initiation. Evidence of a second shear thinning region for emulsions that do not shear thicken discontinuously again confirms assumptions on the continuity of the silicone phase for these compositions.

There is some signature of a cell spanning structure formed that either is unable to sustain the high stress or there is slip between the sample and the shear cone occurring due to the silicone. This cell spanning structure would most likely be similar to that observed in some emulsions with droplets of high viscosity liquid crystalline polymers (Orihara, H., Miwa, N., Doi, M., “Response properties of immiscible polymer blend electrorheological fluids,” J. Rheol. 45(3), 773-781 (2001)) where under shear the droplets elongate and form bridges.

Also unknown is the slip at the fluid-fluid interface. The large viscosity difference at high stress values could place a large importance on the matrix-droplet interface. At stress values greater than the critical stress, the shear thickening fluid is essentially rigid; it could be hypothesized that the bulk fluid viscosity drops off after the shear thickening due to a slip between the silicone and the shear thickening fluid phases. This is reasonable due to the large viscosity ratio in this region.

Phase Inversion

The possibility of microstructure formation within the emulsion under shear flow at high stress levels, such as a phase inversion from discrete to continuous, can be analyzed by first looking at FIG. 9. The viscosity for a constant stress value changes drastically with increasing composition. In the region of lower volume fraction the viscosity-concentration relationship is relatively independent of stress. In the region of high shear thickening fluid volume the relationship is more dependent on the stress. This is due to the shear thinning behavior of these samples. The flip from a simple relationship to a highly stress dependent one occurs when the volume fraction of shear thickening fluid is approximately one half. This suggests a phase inversion point occurring in this regime, presumably shifting from a continuous phase of silicone to one of shear thickening fluid.

The dynamic frequency sweeps for each material were shown earlier in FIG. 11 and can be used to further support our assumptions about phase inversion. The crossover frequency, G′=G″(G′_{c}), for each sample was determined by finding the intersection of the two curves. For samples not showing crossover within the range of the testing limits the crossover frequency was determined by extrapolating the moduli curves to an approximate intersection. The resulting relaxation times are shown in FIG. 22 with a distinct shift in the region where Φ_{STF}˜50.

This shift in dominant relaxation time between the two groupings supports the phase inversion suggestion. Where there is a continuous phase of silicone oil the dominant relaxation time of the system is close to the value of that of the pure component. Conversely, the relaxation time of the system is close to the value of pure shear thickening fluid when the volume fraction is higher than half.

Similar result can be determined by normalizing the elastic modulus, G′/G′c, and then plotted with respect to frequency, FIG. 23. The result is the formation of two groupings, one around the curve for the pure shear thickening fluid and one around the pure silicone. This result further supports that the dominate material is indeed a continuous phase but does not lead to information about the continuity of the second component leaving open the possibility that there exists a region where both material phases are continuous.

The rheology of a novel emulsion of silicone oil and a polyethylene glycol based shear thickening fluid is studied. The shear thickening response is observed for all volume fractions of shear thickening fluid in the emulsion tested, as low as 10 vol %. The viscosity behavior for various compositions of the emulsion are modeled using the Cross model for colloidal suspensions and were found to correlate well. At low shear the system can be classified as both a positive and negative deviating blend from the log additivity rule. This behavior is due to phase inversion.

The droplet size evolution is found to play a predominate role in the behavior of the emulsion system between forward and reverse stress sweeps with an observed hysteresis. The hysteresis present clearly shows that the silicone is continuous at the low shear rates and possible presence of a continuous shear thickening phase at high shear rate.

The microstructure of the system is discussed and a possible phase inversion point found in the region where the mass of each component is approximately the same. The difference between shear thickening response in the dynamic region and under shear suggests a structural change with the introduction of a shearing force.

This work has laid the foundation for studying the interface and interaction between a non-Newtonian fluid and Newtonian fluid in an emulsion. It has also shown the interesting viscosity behavior and the phase microstructure that results from emulsifying the two different fluids. Further study probing the phase microstructure under varying rates of shear flow could prove to be interesting and could easily be conducted in a glass couette geometry. One could also extend this work to study the response of a single droplet of shear thickening fluid to varying stress loads. This could prove interesting, as the discontinuous shear thickening of the STF should have a dramatic impact on droplet deformation as well as breakup and coalescence.

Colloidal Shear Thickening Fluid in Polymer Composites

Concentrated colloidal suspensions demonstrate a stress induced microstructural change from a low viscosity fluid to a highly viscous structured material referred to as shear thickening. These shear thickening fluids (STF) have been shown to have utility in the fabrication of energy dissipative devices, such as shock absorbers (Hesse, H., U.S. Pat. No. 4,503,952), (Rosenberg, B. L., U.S. Pat. No. 3,833,952), (Sheshimo, K., U.S. Pat. No. 4,759,428) and more recently in the fabrication of ballistic fabric composites (Lee, Y. S., Wetzel, E. D., and Wagner, N. J., “The ballistic impact characteristics of Kevlar woven fabrics impregnated with a colloidal shear thickening fluid”, J. Mat. Sci. 38, 2825-2833 (2003)). Though ballistic impact testing of Kevlar fabrics impregnated with shear thickening dispersions have demonstrated marked improvement over the performance of neat Kevlar fabrics, tests performed on non-constrained shear thickening fluids alone demonstrate only limited ability to absorb the energy of impact during the passage of the projectile. Impact or deformation of composite materials containing small, dispersed-phase STF regions may be able to generate the stresses necessary to initiate the shear thickening response. The exploitation of the energy dissipative benefits of STFs in solid and foamed composites will provide a range of energy absorptive responses for a flexible material format.

The shear thickening fluid (STF) used is the same as that which is discussed in Part I of this paper. The fluid was prepared using amorphous silica powder (Nippon Shokubai KE-P50) dispersed in 200 MW Polyethylene Glycol (Clarient PEG-200). The average diameter of the silica particle was 450 nm and the density was determined to be 2.055 g/cm³ at 25° C. using a density meter (Anton-Paar DMA 48). The silica particles were first added to PEG at a weight fraction of 30% with the diluteness of the system aiding in particle dispersion. This mixture was then centrifuged for 2 hours and the supernatant removed, leaving a cake of close packed silica particles (Φ˜64%). Very small amounts of PEG were added to the silica particles until the mixture reached the desired flow properties, higher additions of PEG at this stage would decrease the viscosity of the solution. Thermogravimetric analysis was conducted on the sample to determine the weight fraction of particles in this final solution, 59.52%, which was then used to determine the volume fraction of silica in PEG, 49 vol %.

Four sizes of polyurethane open cell foam were used, with an average pore size of 60, 70, 80, and 90 pores per inch (ppi). They were each received from Foamex International and have a density of ˜0.1 gm/cm³.

Teflon Based

A negative Poisson ratio Teflon foam was acquired from W. L. Gore for testing purposes. The material construction does not allow the shear thickening fluid to wet the foam due to the surface tension. These foams must be tested with a silicone oil based shear thickening fluid. No further work was performed with Teflon foam.

Non-Foamed Rubbers

Neat samples of various silicones were cured as were samples with encapsulated regions of shear thickening fluid. To encapsulate the shear thickening fluid the components were massed and mixed together by hand until an emulsion of the silicone and shear thickening fluid was generated. This emulsion was set into a mold and put in the oven at seventy degrees Celsius until cured. The oven was used to speed the kinetics of the polymerization.

Silicone

A two-part polymerizable silicone oil, acquired from GE Silicones (SLE5700-D1), has been rheologically characterized in Part I of this paper. The silicone can be polymerized with the addition of the catalyzing agent, Part B, in a 50/50 weight ratio with Part A.

Silastic

Two elastic silicones were tested, Silastic T2 and Silastic S with green curing agent (Dow Corning). Silastic T2 is a translucent high strength mold making silicone and is created using a 10:1 ratio. Silastic S is also a high strength silicone with the same mixing ratio. Both cure at room temperature and are immiscible with shear thickening fluid.

Closed Cell Foam

It should be noted that numerous attempts were made to foam the silicones used in section 2.1.3 by adding isopropyl alcohol (IPA) to the mixture before curing. These attempts were unsuccessful as the silicones lacked the polymer chain functionality for the IPA to react and subsequently foam the mixture.

A two part room temperature foam was acquired from Quantum Foam Resins, LDF 8, with a mix ratio of 100:7. The density of the first part is ρ_{QF}_{_{—}}_{A}=1.2 gm/cm³ and plays an important part in the suspension of the shear thickening fluid, ρ_{STF}=1.67 gm/cm³. If the density ratio were too large the settling time of the shear thickening fluid would be on a time scale less than that of the curing process. A florescent dye (DayGlo Color Corp, D-824) was added to the shear thickening fluid to aid in visual recognition of shear thickening inclusions. The following foam compositions were formed, Table 5.

TABLE 5
Closed Cell Foam Compositions, Quantum Foam Resins LDF 8

| | | | Mass of Shear |
|---|---|---|---|
| | Part A | Part B | Thickening Fluid |
| Φ_{STF} | (gm) | (gm) | (gm) |
| 0 | 4.0528 | 0.3226 | 0 |
| 10 | 3.5655 | 0.2427 | 0.5351 |
| 25 | 3.0468 | 0.2051 | 1.4597 |
| 50 | 2.0814 | 0.1446 | 2.8718 |

Testing

Dynamic Rheological Testing

The dynamic rheological response of the materials was tested using a 25 mm parallel plate rheometer (Parr Physica MCR500). Testing was performed at a constant 25° C. with a peltier and constant temperature water bath used for temperature control. The normal force of the plate on the sample was recorded before and during each experiment. The force was used as a measure of compression, and an attempt to decrease sample slip, a set normal force was applied to the sample during testing. Samples were prepared for testing by using a polymer die to cut the samples into 25 mm circles, with the height of the sample cut to ¼″. The small angle oscillatory measurements were conducted on the samples at a controlled normal force for various stresses and frequencies.

Controlled Compression

The response of the materials to a controlled compression in between two parallel plates was tested. The compression was done between two parallel plates on a rheometer (25 mm Parallel Plate, Paar Physica MCR500) using the analog of an adhesive tack test. The velocity of the upper plate was controlled and the resulting force load recorded. The velocities were measured from 0.1 mm/s to 5 mm/s.

The tests were performed on foam samples (Table 6) cut into a 25 mm diameter circle with a thickness of 0.25 inch. The shear thickening fluid was added to the foam until the shear thickening response could be felt throughout the foam with pressure applied between fingers. The amount of shear thickening fluid in the foam composite is less than the porosity of the foam, and there is air inside of the foam-STF composite.

TABLE 6
Polyurethane Based Open Cell Foam Composites

| Sample | Mass Foam (gm) | Mass STF (gm) |
|---|---|---|
| 1 | 0.1773 | 0 |
| 2 | 0.1743 | 7.3557 |
| 3 | 0.1771 | 8.4029 |

Drop Testing

A ¾ inch diameter spherical ball bearing with a mass of 28.81 grams was used for impact testing. The impact was recorded using a digital camera.

Impact testing was performed on the polyurethane based open cell foams with the compositions given in Table 6. The spherical ball bearing was dropped onto the target by hand from an approximate distance of one foot. The results were recorded using a digital camera (Sony P51) in quick snap mode exposing thirty frames per second.

Ballistic Experiments

Targets were constructed to test the impregnation of open cell foams with shear thickening fluid against a ballistic impact.

The targets were tested with the Helium Gas Fragmentation Test Stage at the Army Research Laboratory in Aberdeen, Md. Targets were held at room temperature and the projectile is a metal cylinder of 17 grains (1.1 grams) and 22-caliber diameter (0.56 cm). The characteristic shear rate for this test is 25000/0.56≈45,000 sec⁻¹. These targets were mounted onto clay (18 in×21 in) held in a wood box in accordance with NIJ Standard 01.01.04. The standard clay witnesses (Plastalina modeling clay, Van Aken) were used to measure depth of penetration.

The size of all targets was 4.76 cm×4.76 cm, and the foam layers were cut to a thickness of either 0.25 or 0.125 of an inch, as noted in target description. The Kevlar fabric used in all composite target constructions was plain-woven Hexcel Aramid (poly-paraphenylene terephthalamide), high performance fabric Style 706 (Kevlar KM-2, 600 denier) with an areal density of 180 g/m². To prevent leakage of STF out of the target assembly and because Kevlar is known be sensitive to moisture, heat-sealed polyethylene film (Ziplock bags sealed using a ULINE KF-200HC heat sealer) is used to encapsulate the targets.

The configuration of the foam-Kevlar composites is given in Table 7 and visually shown in FIG. 24.

TABLE 7
Ballistic Targets (K = layer of Kevlar, F = Layer of Foam)

| | | Foam Pore | Type of | Mass of | Mass Of | Mass of | Mass of |
|---|---|---|---|---|---|---|---|
| Target | Description | Size (ppi) | Fluid | Kevlar (g) | Foam (g) | Fluid (g) | Target (g) |
| A1 | 2K + ¼″ F + 2K | 100 | STF | 1.87 | 0.94 | 55.090 | 57.900 |
| A2 | ¼″ F + 4K | 100 | STF | 1.86 | 0.97 | 56.740 | 59.570 |
| A4 | 2K + ⅛″ F + 2K | 100 | STF | 1.89 | 0.54 | 26.650 | 29.080 |
| B1 | 2K + ¼″ F + 2K | 60 | None | 1.83 | 0.94 | 0.000 | 2.770 |
| B2 | 2K + ¼″ F + 2K | 100 | None | 1.93 | 0.96 | 0.000 | 2.890 |
| B3 | ¼″ F + 4K | 60 | None | 1.83 | 0.94 | 0.000 | 2.770 |
| B4 | 2K + ⅛″ F + 2K | 100 | None | 1.85 | 0.43 | 0.000 | 2.280 |
| C1 | 2K + ¼″ F + 2K | 100 | 200MW PEG | 1.82 | 0.94 | 29.15 | 31.910 |
| C2 | 2K + ¼″ F + 2K | 60 | 200MW PEG | 1.87 | 0.89 | 30.94 | 33.700 |
| C3 | 2K + ¼″ F + 2K | 60 | 600MW PEG | 1.86 | 0.89 | 27.15 | 29.900 |

The containment of shear thickening fluid inside of different polymer composites was tested.

Silicone Rubbers

The ability to encapsulate shear thickening fluid inside of the polymer matrix was studied by mixing quantified amounts of shear thickening fluid with the silicone precursors. For all silicone rubbers tested the shear thickening fluid was easily mixed into the precursor. In FIG. 25a the discrete regions of STF formed in the silicone can be observed in a sample 18% mass STF. FIG. 25b shows the ribs of shear thickening fluid formed in Silastic T2 (28% mass STF), highlighted with an arrow, upon curing.

FIG. 26 shows a large droplet of shear thickening fluid (white area) that was contained inside of a cured Silastic T2 silicone sample. Close observation of the shear thickening fluid displays cracks due to fracturing of the fluid when the rubber was stretched. These fissures disappear once the fluid has relaxed.

There are many air bubbles contained within the cured rubber and this problem could be alleviated with the use of a vacuum chamber prior to curing the sample.

When the rubber sample shown in FIG. 26 is stretched the region of shear thickening fluid visually changes from translucent to opaque. When fully relaxed the index of refraction of the shear thickening fluid is closely matched with that of the silicone and the droplet appears translucent. When a strain is applied to the sample the shear thickening fluid hardens, and turns into a region of opaqueness. If a large enough strain is applied the fluid can be torn apart and fissures such as shown above are readily formed. When the strain is removed the fluid relaxes back to its original translucent state.

Open Cell Foam

Shear thickening fluid was added to the open cell foams and found to wet very well. The shear thickening response of the shear thickening fluid in the open cell foam is observable by hand in both foams with large and small pores (60-100 ppi). The reaction of the material is that of the neat fluid. At fast impact speeds the foam appears to act like a solid and at low strain rates the composite can be easily compressed and the fluid is seen to flow out of the pores. This was further quantified with the impact testing shown later.

Closed Cell Foam

The addition of shear thickening fluid to the closed cell foam was found to inhibit the catalyzing agent used to foam and cure the resin. It formed a goop similar in consistency to baking dough. Even addition of twice as much catalyzing agent to the mixture does not allow the curing of the foam. Future study would involve polymer chemistry to determine possible approaches to achieve the desired closed cell foam with encapsulated STF.

Dynamic Testing

Open Cell Foams

FIG. 27 shows a foam-STF composite in a parallel plate. Upon slow compression, stresses between the plates below critical stress of shear thickening, the fluid was found to flow out of the foam and collect at the base. Upon retraction of the upper plate to the original position some of the fluid would be wicked into the foam, however not all was taken into the pores.

Dynamic tests were performed on closed cell foam composites with results shown in FIGS. 28a and 28b. Analysis of the dynamic properties of a similar shear thickening fluid can be found in Lee and Wagner (Lee, Y. S., Wagner, N. J., “Dynamic properties of shear thickening colloidal suspensions,” Rheol Acta 42,199-208 (2003)) and the interested reader is referred to that manuscript. There was a large amount of slip occurring at the plate-foam interface at high rotation angles. The amount of slip was not quantified but could be eliminated if the foam were to be attached to the plates using an adhesive. Upon close analysis of the viscous modulus in FIG. 28a for the STF-Foam composite there is a shear thickening effect observed at high strain. It should also be noted that the shear thickening fluid was observed to thicken visually at these high stress levels. This visualization, of the ST effect, was possible due to the weeping of the fluid from the foam, showing ST at the edges. The inability to reduce the interfacial slip and the known presence of large amounts of slip could be the reason a discontinuous shear thickening transition is not observed.

Silicone Composites

Both neat silicone and STF-Silicone composites were tested at various levels initial force load. The storage and loss modulus of the rubber is shown in FIGS. 29a and 29b. The same problems were encountered for the silicone as in the open cell foams. There was a tremendous amount of slip present suggesting another testing method may be more appropriate.

Compression Testing

The force required to compress open cell foams impregnated with shear thickening fluid is compared to the compression of the same neat open cell foam. The results are shown for the different velocities in FIGS. 30a and 30b. FIG. 31 shows the neat and STF-Foam composites together.

A closer analysis of the different response of the two materials can be seen in FIG. 32 where the rate of compression is held constant between the two samples. Interestingly the STF modifies the foam response in a somewhat unexpected manner, allowing the foam to be more “flexible” at low rates while resisting deformation at higher rates.

Impact Testing

Open Cell Foam

The response of both neat and impregnated open cell foams was tested against the impact of a stainless steel ball bearing. The impact of the bearing on the two different STF-Foam composites is readily visible from FIGS. 33a and 33b. The pictures were taken on a digital camera with a 1/30″ frame rate with the first frame shown in the upper left moving right. In FIG. 33a the neat foam response is very much like that of no foam, where the energy of impact is not absorbed. FIG. 33b shows the energy absorption capability of the STF-Foam composite. The rebound height of the bearing is noticeably subdued and almost all of the impact energy is absorbed, a response expected from an inelastic solid.

Fragment Simulation Testing of Open Cell Foam Composites

The ballistic testing was performed on the targets using the NIJ clay backing for each one. The results are given in Table 8.

TABLE 8
Results of Ballistic Impact Experiments

| | Mass of | Depth of | Impact | Residual | Initial | Abosrbed | Energy |
|---|---|---|---|---|---|---|---|
| | Target | Penetration | velocity, Vi | velocity, Vr | Energy | Energy | Dissipation |
| Target | (g) | (m) | (m/s) | (m/s) | (J) | (J) | (%) |
| A1 | 57.900 | 0.0220 | 249.7 | 118.9 | 34.3 | 26.5 | 77.33 |
| A2 | 59.570 | 0.0160 | 248.7 | 85.5 | 34.0 | 30.0 | 88.19 |
| A4 | 29.080 | 0.0260 | 251.5 | 141.1 | 34.8 | 23.8 | 68.50 |
| B1 | 2.770 | 0.0255 | 250.7 | 138.3 | 34.6 | 24.0 | 69.55 |
| B2 | 2.890 | Not Recorded | — | — | — | — | — |
| B3 | 2.770 | 0.0237 | 251.4 | 128.3 | 34.8 | 25.7 | 73.94 |
| B4 | 2.280 | 0.0267 | 250.1 | 145.0 | 34.4 | 22.8 | 66.38 |
| C1 | 31.910 | 0.0177 | 244.3 | 94.9 | 32.8 | 27.9 | 84.90 |
| C2 | 33.700 | 0.0205 | 251.4 | 110.5 | 34.8 | 28.1 | 80.68 |
| C3 | 29.900 | 0.0238 | 248.6 | 128.9 | 34.0 | 24.9 | 73.12 |

The ballistic results of the open cell foam are comparable to the neat Kevlar targets. The neat Kevlar and STF-Kevlar (no foam) testing is taken from previous work and one is reference to the work of Lee et al. for careful analysis of these data points.

An image of an impacted ballistic target is shown in FIG. 35. The 4 Kevlar layers preceding the neat foam layer were pulled through the foam layer. Closer analysis of the foam impact site shows a clean penetration, with only localized damage.

The results for targets with STF added to the foam layer were observed to be the same. For the STF-Foam composite targets the penetration into the foam was the size of the projectile and it appeared to have an outward effect on the STF. The area surrounding the impact was noticeable harder, such that it appeared to have left a ring of close packed particles surrounding the impact site.

The results of ballistic impact testing preliminarily show that containment of STF in the open cell composite does not have the same effect of containment in the Kevlar weave. This is expected due to the drastic difference in the neat material ballistic performance.

The performance enhancement of the shear thickening mechanism has yet to be exploited in the open cell foam system. The energy absorption that was observed in the drop testing was not visible in the ballistic impact testing. This suggests that you must have the shear thickening fluid contained in front of the projectile, possibly in a negative Poisson ratio Teflon foam or closed cell foam composite. A problem encountered with the experiment was that the foam is well loaded because of the high viscosity of the STF.

The mixing and curing of these rubbers (GE Silicone, Silastic T2, Silastic S) worked well. When mixed with the shear thickening fluid discrete inclusions of STF could be formed. This work has shown that containment of shear thickening fluid within a polymer composite is possible and that the STF remains active.

The ballistic tests performed are inconclusive to possibilities of the STF-Foam composite. The results help to identify the need for containment of the shear thickening fluid, consistent with previous testing. In order to accurately test improvement with the STF-Foam composite there is a need to exploit foam in a situation where it can absorb energy and doesn't have to deal with the point of the projectile. This situation could possibly be the last layer of a very large Kevlar target or the backing for composite armor where the tensile strength of the foam would not be an issue.

Drop testing is conclusive that there is an exploitable response of the STF-Foam system. There is an obvious visual difference in the impact of an open cell foam impregnated with shear thickening fluid. This energy absorption is noticeable and possibly exploitable for practical application. There is an apparent “hardening” of the foam during the impact as the shear thickening fluid transitions from its fluid to flow jammed state.

Compression testing needs an instrument with a higher velocity capability. The response noticed between the neat foam and the STF-Foam composite was interesting. The shear thickening response of the STF-Foam composite that is observable by hand and with the drop testing was not quantifiable in the compression testing due to a velocity limitation. The maximum strain rate accessible by the machine was not sufficient to reach the critical stress of the shear thickening fluid.

The results of the dynamic rheological tests showed a shear thickening of the viscous modulus in the open cell foam-STF composite but no clear result of the STF rubber composites. It is not clear what the actual strain on the sample was because of the large amount of slip present between the parallel plates and the sample. Further study would include the use of disposable plates so that the sample could be attached, removing any possibility of slip.

Stab Resistance of Fabric-Shear Thickening Fluid Composites

Herein we found novel energy dissipative nature of composites of fabrics containing shear thickening fluids and their improved stab resistance capabilities. Significant research and development effort has led to the development of fabric-based armors which protect against ballistic threats (Bogetti and Cheeseman, Comp. Struct. v61. p 161-173, 2003). However, new materials are required to address the emerging need for stab protection. In the civilian sector, stab resistant armors are primarily utilized in correctional facilities, where the most likely threats to officers are improvised, sharp objects. Strict gun ownership restrictions in some countries, especially in Europe, have also led to an increase in the proportion of assaults which are committed with knives. Correspondingly, police forces in these countries are increasingly requesting stab-resistant armors. For military applications, a demand exists for protection in close-quarters, urban conflict. In addition to direct stab assaults, these environments often require operating near sharp objects such as broken glass, debris, and razor wire.

It is important to separate stab threats into two specific mechanisms: puncture and cut. Puncture refers to impact by instruments such as ice picks or awls, which have a sharp tip but no cutting edge. These threats are of primary concern to correctional officers, since sharply-pointed objects are relatively easy to improvise. Cut refers to impact by knives with a continuous cutting edge. Knife threats are generally more difficult to stop than puncture, since the continuous cutting edge presents a longer sharpened region more capable of compromising protective materials during a stab-type impact.

A number of commercial stab-protective materials are available. Chain mails, such as those provided under the trade name Stahlnetz® (Schlachthausfreund Gmbh, Handeloh, Germany), are frequently used for cut protection in commercial applications such as meat packing, and have been incorporated into some stab-resistant vests. These mails, however, do not provide puncture resistance. Other commercial designs utilize layers of titanium foil, which offers both cut and puncture resistance. However, both the foil and mail solutions are relatively heavy, and offer little ballistic resistance. The DuPont Company produces Correctional™ Kevlar® fabric, consisting of low denier Kevlar yarns tightly woven into a high yarn-count fabric. This fabric possesses excellent puncture protection, and some cut protection. However, the expense of producing and weaving low denier Kevlar yarns makes these materials relatively expensive. Other designs utilize rigid metal, ceramic, or composite plates. These rigid armors can offer excellent stab protection, but are bulky and inflexible, making them uncomfortable to wear and difficult to conceal.

More recent material research efforts include thermal-sprayed hard ceramic coatings onto woven aramid fabrics (Gadow and Niessen, Ceramic Transactions. v151, 2003). These hard-coated fabrics demonstrate increases in energy absorption during quasistatic stab tests, as compared with uncoated fabrics. However, these coatings also add significant weight to the fabric. Other recent work reports knitted fiber constructions for enhanced cut resistance (Flambard and Polo, J. of Advanced Materials. v36 n1. p 30-35, 2004).

In previous studies (Lee et al., J. Mat. Sci., v38. p 2825-2833, 2003) we have investigated the ballistic properties of woven aramid fabrics impregnated with a colloidal, discontinuous shear thickening fluid (STF). A discontinuous STF is a fluid which undergoes a dramatic, sharp increase in viscosity with shear rate, as a result of a material transition from a flowable liquid to a solid-like state when deformed quickly (Maranzano and Wagner, J. Chem. Phys., 114, 10514-10527 (2001).

These investigations have shown that, under some conditions, this STF-fabric composite offers ballistic properties which are superior to neat fabrics. Additionally, the addition of STF was shown to cause little or no increase in the thickness or stiffness of the fabric.

The stab resistance of STF-Kevlar composites is reported, including both stab and cut threats. Tests are performed using a drop tower fixtured with knife and ice pick impactors, based on the National Institute of Justice (NIJ) standard for stab protective armors. Additional results are included for quasistatic stab loading of fabrics. The performance of multi-layer STF-Kevlar targets is compared to neat Kevlar targets of comparable areal density. Both quantitative depth-of-penetration data and qualitative descriptions of fabric damage are reported.

Materials and Methods

Materials

Targets were fabricated from plain-woven Hexcel-Schwebel (Anderson, S.C.) Style 706 (Kevlar KM-2, 600 denier, 34 yarns per inch, plain weave) fabric. Shear thickening fluids were generated by dispersing commercially available, surface functionalized colloidal silica particles (500 nm) in 200 Mw polyethylene glycol. To facilitate the impregnation into the fabric yarns for the preparation of the STF-Kevlar composite target, ethanol was added to the STF as a co-solvent to reduce the viscosity and surface tension of the fluid. Twelve layers of Kevlar fabric, each measuring 35.6 cm×50.8 cm, were individually impregnated with the ethanol/STF mixture, and were subsequently heated in an oven at 70° C. for 20 minutes to remove the ethanol. The final concentration of STF in each Kevlar fabric layer was measured to be near 20% by weight, and the resulting 12-layer target had an areal density of 2.67 kg/m² (0.547 lbs/ft²). These STF impregnated layers were heat sealed in a polyethylene film pouch. A target having a nearly equivalent areal density of 2.65 kg/m² (0.543 lbs/ft²) comprised of 15 layers of neat Kevlar fabric measuring 25.4 cm×35.6 cm was fabricated for experimental comparison.

Drop Tower Stab Testing

The stab tests performed are based on the NIJ Standard 0115.0 for stab resistance of body armor. Two NIJ-specified impactors are used: the “S1” knife, and the “spike” (FIGS. 36a and 36b). The impactors are rigidly mounted to a crosshead in a conventional rail-guided drop tower. The stab targets are placed on a multi-layer foam backing (FIG. 36c), as specified by the NIJ standard. This backing consists of four layers of 5.8-mm-thick neoprene sponge, followed by one layer of 31-mm-thick polyethylene foam, backed by two 6.4-mm-thick layers of rubber (all backing materials from PCF Foam Corp., Cincinnati, Ohio). Synthetic polymer-based Polyart™ witness papers (Arjobex Corp., Charlotte, N.C.) were placed between the target and foam backing, and behind each layer of neoprene sponge.

To perform a stab test, the impactor is mounted to the crosshead, which is then loaded with weights to a specific mass. The crosshead is dropped from a fixed height to impact the target. The velocity of the crosshead at impact is measured using fixed flags and sensors attached to the frame. Impact loads are measured using a load cell mounted to the impactor, but are not reported here. The depth of penetration into the target is quantified in terms of the number of witness paper layers penetrated by the impactor. Note that there are 5 layers of witness paper, so the maximum reported depth of penetration is 5 layers.

Two sets of experiments were performed for each target. For the first set, the drop mass was fixed (2340 g for the knife impactor, 2330 g for the spike impactor) and the drop height was varied from 0.1 to 1.2 m. For the second set of experiments, the drop height was fixed at 0.1 m (velocity of ˜1.4 m/s) and the drop mass was varied from 2340 g to 4470 g for the knife, and from 2330 g to 4470 g for the spike.

Tests were performed on both the neat Kevlar and STF-Kevlar targets. The same targets were used for all tests, with each impact point spaced at least 5.28 mm from the target edge and from previous impact locations. The targets were held in place during testing using nylon straps. The sharpness of the impactors was monitored between tests by using a modified hardness tester (as described by the NIJ standard), and did not vary systematically during the experiments.

The stab testing procedure used in this study differs from the NIJ study in two important ways. First, the NIJ standard uses a two-mass, damped impactor. This damping more closely represents realistic stabbing dynamics than our rigidly-mounted impactor. This damped configuration is also much easier to defeat than our rigid fixture. Therefore, our energy values cannot be directly compared to NIJ-based energy values. Secondly, our configuration uses multiple witness paper layers to measure depth of penetration. The NIJ standard calls for inferring depth of penetration based on measuring the final location of the blade in the backing material. However, this approach is very inaccurate, time-consuming, and does not account for spring-back of the impactor out of the backing. In contrast, our witness paper approach is objective, rapid, and simple to implement.

Quasistatic Stab Testing

To complement the drop tower tests, quasistatic stab tests were also performed. The knife and spike impactors were mounted to the upper grip of an MTS Synergie universal tester, with the target placed below the impactor and on top of the same multi-layered backing as used in the drop tower tests. The impactor was than pushed into the target at a rate of 5 mm/min. to a total depth of 30 mm. Load versus displacement data was recorded.

Results

Drop Tower Stab Testing

FIGS. 37a and 37b present the results of knife impactor stab testing performed at various impact energies using the variable height, fixed crosshead mass test procedure, and the fixed drop velocity procedure, respectively. At all test conditions investigated, the knife impactor was able to cut through the fabric targets, penetrating two or more of the underlying witness papers within the multilayer foam backing. The performance of the STF-impregnated Kevlar fabric exhibited a slight improvement over the neat Kevlar fabric target of equivalent areal density, demonstrating similar depth of penetration results with three fewer layers of Kevlar fabric. More fabric deformation, yarn pullout, and yarn splaying was observed on the neat Kevlar fabric target, as is evident from the photographs presented in FIG. 37c.

FIGS. 38a and 38b below present the results of the spike impactor stab testing. The STF-impregnated Kevlar fabric target demonstrated a significant improvement over the neat Kevlar fabric target. For tests performed at fixed weight and variable drop velocity, no witness papers are penetrated at low impact energies below 12 Joules. At impact energies above this value, we observe penetration comparable to that of the neat Kevlar fabric target. The results presented in FIG. 38b for fixed drop velocity impact testing demonstrate a dramatic improvement in performance of the STF-Kevlar fabric target, where none of the witness layers are penetrated at the crosshead masses investigated. The fabric local to the point of impact for the STF impregnated Kevlar target following spike impact testing (1.4 m/s, 4470 g mass) show that little distortion of the fabric weave occurs (FIG. 38c).

Quasistatic Testing

Quasistatic tests performed with the knife blade impactor were able to penetrate both target materials and showed similar qualitative deformation behavior during loading (FIGS. 39a and 39b). Backing layer penetration was also similar; penetrating 3 witness papers for the STF-Kevlar fabric target and 4 for the neat Kevlar target. However, the STF-Kevlar target exhibits fewer cut yarns and a generally smaller damage zone than the neat Kevlar target (FIG. 39c). This difference can be explained by comparing the load-displacement curves for the two targets (FIG. 40a). The STF-Kevlar target experiences significantly higher loads at peak displacement than the neat Kevlar target (410 N vs. 260 N, respectively). This difference indicates that the STF-Kevlar target is more efficiently loading the blade and resisting penetration, as is evidenced by the damage photographs. This data could also be interpreted in terms of load at a fixed displacement. At a loading of 200 N, the STF-Kevlar target exhibits significantly less blade displacement than the neat Kevlar target (19.9 mm vs. 25.6 mm, respectively), and presumably significantly less damage.

The STF-Kevlar and neat Kevlar targets demonstrated dramatically different responses during quasistatic testing with the spike impactor (FIGS. 41a and 41b). The neat Kevlar fabric target becomes penetrated at a small displacement, and thereafter provides little resistance to further penetration. In contrast, the STF-Kevlar target is not penetrated, even at the maximum displacement of 30 mm. FIG. 41c shows that the neat Kevlar fabric is locally damaged by the spike penetration, while the STF-Kevlar target shows little evidence of damage or penetration. FIG. 40b shows the load-displacement curve for the quasistatic spike tests. Note that the final load for the STF-Kevlar target is dramatically higher than that of the neat Kevlar target (500 N vs. 110 N, respectively).

Discussion and Conclusions

The stab results show that the STF-Kevlar is slightly more efficient than the neat Kevlar against the knife threat, on a per-mass basis. However, note that the STF-Kevlar target has fewer layers of fabric (12 vs. 15) than the neat Kevlar case. Therefore, for the same cut protection, the STF-Kevlar sample is thinner and more flexible than the neat Kevlar material (more detail on thickness and flexibility effects in STF-Kevlar can be found in Lee et al., 2003).

Against the spike threat, STF-Kevlar is dramatically more effective than neat Kevlar, both on a per-weight and per-layer basis. The source of this improved performance can most likely be attributed to the effect of STF on yarn mobility, the ability of yarns to move relative to the impactor and to other yarns. For the neat Kevlar case, the spike does not cut or break yarns, but seems to push them aside. For the STF-Kevlar case, it is likely that the STF binds the yarns together, preventing yarn sliding and separation, so that yarns are engaged more efficiently by the spike. Note that this restriction of yarn mobility is also the likely mechanism by which DuPont Correctional Kevlar (a very tightly woven, high yarn-count fabric) provides puncture resistance.

The quasistatic tests show trends comparable to the drop tower impact results. However, it is interesting to note that while the depth of penetration values for the knife threat against STF-Kevlar and neat Kevlar are comparable, their damage patterns are very different. Much less damage is noted in the STF-Kevlar specimen than the neat Kevlar specimen. Additionally, the loading at a given displacement is measurably greater in the STF-Kevlar specimen than the neat Kevlar specimen. This result suggests that STF-Kevlar can, in statically loaded cases, provide a significantly more cut resistance than neat Kevlar.

The behaviors reported in this study show that STF-Kevlar offers superior stab protection, especially in puncture, relative to neat Kevlar fabric. STF-fabric composites also likely offer advantages relative to some of the existing stab protection technologies. First, since the STF-fabric production requires simple impregnation processes, it is likely that it is applicable to any high-performance fabric. Since this process is relatively simple, and utilizes conventional fabrics, it is likely that the cost of such a material will be significantly less than specialized constructions such as high yarn-count fabrics. The resulting material is thin and flexible, and provides a weight comparable or perhaps less than comparable fabric solutions. Furthermore, our previous studies (Lee et al., 2003) suggest that this same material configuration can also provide enhanced ballistic properties relative to neat fabrics, under certain conditions. Therefore, this material has the potential to provide multi-threat (both ballistic and stab) protection in a single material.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

We claim:

1. A composite which comprises a solid material and a shear thickening fluid wherein said shear thickening fluid is impregnated into a porous solid scaffold material.
